(19) United States
(12) Patent Application Publication
(10) Pub. No.: US 2011/0063437 A1
(43) Pub. Date: Mar. 17, 2011

(54) DISTANCE ESTIMATING DEVICE, DISTANCE ESTIMATING METHOD, PROGRAM, INTEGRATED CIRCUIT, AND CAMERA

(76) Inventors: Tatsumi Watanabe, Osaka (JP); Yasuhiro Kuwahara, Osaka (JP); Takeshi Ito, Osaka (JP); Bumpei Toji, Gifu (JP); Daisuke Sato, Osaka (JP); Shinya Kiuchi, Osaka (JP); Yoshiaki Owaki, Osaka (JP)

(21) Appl. No.: 12/922,544

(22) PCT Filed: Jul. 29, 2009
(86) PCT No.: PCT/JP2009/003574

§ 371 Date: Nov. 3, 2010

(30) Foreign Application Priority Data
Aug. 20, 2008 (JP) 2008-211661

(51) Int. Cl. H04N 7/18

(52) U.S. Cl. 348/140; 348/E07.085

(57) ABSTRACT

Conventionally, there has been a danger that CCD saturation may occur because of the influence of the shot noise and the environment light if a higher resolution of a distance image showing the distance to an object present in a target space and a higher frame rate are achieved when the distance image is estimated by the TOF method, and the distance accuracy may degrade. An emission frequency selecting unit (7) receives light (S2) reflected from the object when a light source does not emit light and selects illumination light (S1) having an emission frequency insusceptible to the environment light according to the frequency analysis of the reflected light (S2). An image creating unit (6) selects a light source emitting the illumination light having the optimum emission frequency from among prepared light sources (9A to 9N), receives reflected light of the illumination light from the selected light source, and creates the distance image showing the distance to the object. The environment light can be mitigated during light reception, and the noise influence on the distance accuracy can be mitigated when a light-receiving element unit (2) exhibiting higher resolution is used.

### TECHNICAL FIELD

The present invention relates to a device and a method for imaging a target space and estimating a distance to an object in the target space in order to improve a sense of depth and a stereographic effect of an image taken by an imaging device such as camcorder, digital still camera (DSC) or the like.

### BACKGROUND ART

A technique of three-dimensional measurement of a space is expected to be applied in many fields, and has been tried to be utilized by various methods. Typical methods among such methods include: a light section method by scanning with laser slit light; triangulation methods represented by a method using stereoscopy; a TOF method of measuring a distance by irradiating a measurement object with illumination light and measuring Time of Flight (TOF) for the irradiated light to return from the measurement object; and the like.

When three dimensional measurement of a space is performed by using a triangulation method, a target space (a three dimensional space which is an object to be imaged) has to be scanned with light in order to obtain three dimensional information of the target space. Thus, it takes a relatively long time till the three dimensional information is obtained for the entire target space. Therefore, the triangular method is said to be unsuitable for application such as tracking a moving object, or the like.

On the other hand, when three dimensional measurement of a space is performed by using the TOF method, laser beam scanning as in the triangular method is not required. Therefore, the three dimensional measurement of a space by the TOF method can rapidly detect a distance to a subject (a distance from an imaging device to the subject) in pixel units of television images (imaged picture), and also, a relatively wide range of distance measurement can be set (the range of distance measurement of about 3 m or longer can be set). Further, since the three dimensional measurement of a space by the TOF method can use LED light sources instead of laser light sources, even people can be imaged safely. Because of such advantages, various methods have been reported for the three dimensional measurement technique by the TOF method, and also, examples of product realization as distance sensors have been reported.

The TOF method measures a distance in a three dimensional space based on Equation 1. Specifically, in the TOF method, the distance is calculated as follows. It is known that light speed C=3.0×10̂8 [m/sec] (herein, “X̂Y” represents “X to the power of Y”, and the same is true of the following description). Thus, if a time period during which the light is emitted from the light source which is a measurement reference point, and illuminates a measurement object at a measured point, and the reflected light from the measurement object returns to the light source which is the measurement reference point, i.e., a time period required for the light to travel from the light source to the measurement object and come back, is Δt, a distance L between the measurement reference point and the measured point is obtained from the following equation.

$$\begin{matrix}Equation 1 & \\ L = \frac{c \cdot Δ t}{2} & ( 1 )\end{matrix}$$

There are various systems in the TOF methods. Typical systems are a phase TOF system and a pulse TOF system.

The phase TOF system is a system in which measurement object is irradiated with light beam subjected mainly to intensity modulation, and the light reflected from the object is detected and subjected to photoelectron transformation. The transformed photoelectrons are accumulated in one of a plurality of accumulation units with shifts in time, and distance information is created in accordance with the number of photoelectrons accumulated in the accumulation unit.

The pulse TOF system is a system in which the measurement object is irradiated with a light beam with pulses, and a distance is obtained based on a phase difference between the light reflected from the measurement object and the measurement light beam. Scanning with the measurement light beam is performed two-dimensionally, and distances from various points are measured for measuring a three dimensional shape.

In the phase TOF system, the distance is measured with phase amount Δφ instead of Δt in Equation 1. In the phase TOF system, the maximum detection distance Lmax corresponds to the case where the phase amount Δφ is 2π (T for Δt: one cycle duration of modulation intensity), and is obtained from the following equation. In other words, the maximum detection distance Lmax depends on modulation frequency f of the measurement light beam, and is determined by the following equation.

$$\begin{matrix}Equation 2 & \\ {L}_{max} = \frac{c}{2 f} & ( 2 )\end{matrix}$$

Further, detection distance L at the phase amount Δφ is as shown in Equation 3.

$$\begin{matrix}Equation 3 & \\ L = \frac{( {L}_{max} \times Δ φ )}{2 π} & ( 3 )\end{matrix}$$

In such a case, there is a problem that, based on Equation 2, when the distance to the measurement object equals to or longer than a wavelength corresponding to a cycle of intensity modulation of the measurement light beam, it is theoretically impossible to uniquely determine the result of the distance calculation (i.e., the distance to the measurement object cannot be specified).

On the other hand, in the pulse TOF system, there is a problem that a time period required for obtaining the distance image becomes long since it is necessary to physically scan with the measurement light beam such as laser light or the like emitted from the light source in vertical and horizontal directions using a wobble mirror, polygon mirror, or the like for obtaining the distance image by scanning with the measurement light beam in a two dimensional manner.

In the current state, there are a number of techniques for performing three dimensional measurement of a space by using a system similar to the phase TOF system (see, for example, Patent Literatures 1 and 2). Hereinafter, a conventional distance estimating device utilizing the phase TOF system (Conventional Examples 1 and 2) are described.

### Conventional Example 1

First, Conventional Example 1 (techniques described in Patent Literature 1) is described.

FIG. 23 is a block diagram showing a structure of a distance estimating device 900 of Conventional Example 1. The distance estimating device 900 comprises a light projection unit 902 which can illuminates an object OBJ1 with illumination light S906 subjected to amplification modulation, and an imaging unit 903 which can receive reflected light S907 from the object with an imaging gain varied in accordance with time elapse and can take an optical image of the object. Further, the distance estimating device 900 comprises a signal processing unit 904 for converting a video signal 5904 from the imaging unit 903 into three dimension information signal 5905, and a signal generating unit 901 for generating an illumination light modulation signal 5901, an imaging gain modulation signal 5902, and control signals S903a and S903b.

FIG. 24 is a schematic view showing a summary of a distance detection process in the distance estimating device 900 of Conventional Example 1.

As shown in FIG. 24, in the distance estimating device 900, an object is irradiated with infrared light with light intensity being modulated rapidly, and the light reflected from the object is imaged by an ultra-high speed shutter.

As schematically shown in an upper part of FIG. 24 (Ex901 of FIG. 24), the distance estimating device 900 irradiates objects O1 and O2 with illumination light (measurement light beam) which is modulated such that the light intensity decreases as time elapses (for example, illumination light which has a light intensity modulated over a time period indicated by tr1 in FIG. 24). The distance estimating device 900 obtains the light reflected from the objects O1 and O2 at a predetermined shutter timing and a shutter time (a shutter time indicated by ts1 in FIG. 24), and converts into imaged pictures. The light reflected from the objects O1 and O2 are modulated such that the light intensity decreases as time elapses. Thus, the light intensity of the light reflected from the object O1 which is closer to the distance estimating device (camera) 900 is large while the light intensity of the light reflected from the object O2 which is farther from the distance estimating device 900 is small (since the illumination light is modulated such that the light intensity decreases over time, the light intensity of the light reflected from the object O1 which has a short time of flight for the light (a time period for the light emitted from the distance estimating device 900 to reflect upon the object O1 and return to the distance estimating device 900) is large (an amount of decrease in the light intensity is small), and the light intensity of the light reflected from the object O2 which has a long time of flight for the light is small (an amount of decrease in the light intensity is large)).

Therefore, when the light reflected from the objects O1 and O2 are obtained at a predetermined shutter timing and a shutter time (a shutter time indicated by ts1 in FIG. 24) in the distance estimating device 900, an image I1 of the object O1, which has a short time of flight for the illumination light, becomes bright, and an image I2 of the object O2 becomes dark in the imaged picture A. In other words, the distance information is represented as brightness of images in the imaged picture A.

However, the brightness of the imaged picture A is affected by reflectance of the objects, spatial nonuniformity of the irradiation light amount, damping effects due to distances in the diffused reflected light amount, and the like.

Therefore, the distance estimating device 900 performs the following process in order to compensate such influences.

As schematically shown in a lower part of FIG. 24 (Ex902 of FIG. 24), the distance estimating device 900 irradiates the objects O1 and O2 with illumination light (measurement light beam) which is modulated such that the light intensity increases as time elapses (for example, illumination light which has a light intensity modulated over a time period indicated by tr2 in FIG. 24). The distance estimating device 900 obtains the light reflected from the objects O1 and O2 at a predetermined shutter timing and a shutter time (a shutter time indicated by ts2 in FIG. 24), and converts into imaged pictures. The light reflected from the objects O1 and O2 are modulated such that the light intensity increases as time elapses. Thus, the light intensity of the light reflected from the object O1 which is closer to the distance estimating device (camera) 900 is small while the light intensity of the light reflected from the object O2 which is farther from the distance estimating device 900 is large.

Therefore, when the light reflected from the objects O1 and O2 are obtained at a predetermined shutter timing and a shutter time (a shutter time indicated by ts2 in FIG. 24) in the distance estimating device 900, an image I1 of the object O1, which has a short time of flight for the illumination light, becomes dark, and an image I2 of the object O2 becomes bright in the imaged picture B. In other words, the distance information is represented as brightness of images in the imaged picture B.

In the distance estimating device 900, brightness ratio between the imaged picture A and the imaged picture B obtained as described above is taken to create a distance image with the influence by the reflectance and the like being compensated (a distance image C in FIG. 24).

In the distance estimating device 900, TOF can be obtained by division related to brightness of two imaged pictures as described above. Therefore, theoretically, influence of diffusion of infrared light, reflectance of objects, directions of reflection, environment light and the like can be cancelled. However, since the distance estimating device 900 needs to secure a certain degree of light intensity of the light reflected from the objects, light sources such as light emitting diode array consisting of a plurality of light emitting diodes or the like has to be used, resulting in a disadvantage that the size of the device becomes large.

### Conventional Example 2

Next, Conventional Example 2 (techniques described in Patent Literature 2) is described.

FIG. 25 is a block diagram showing a structure of a distance estimating device 950 of Conventional Example 2. The distance estimating device 950 comprises an emission source 951 which irradiates a target space with illumination light S9511, a light detection element 952 which receives light from the target space and outputs an electric signal of an output value which reflects the received light amount, a control circuit unit 953 which controls the emission source 951 and the light detection element 952, and an image creating unit 954 which performs an image creation process in response to the output from the light detection element 952. The distance estimating device 950 further comprises a light receiving optical system 955. The light detection element 952 has a plurality of photosensitive portions 9521, a plurality of sensitivity control portions 9522, a plurality of charge integrating portions 9523, and a charge extraction portion 9524 as shown in FIG. 25.

The emission source 951 irradiates a target space with light modulated with a modulation signal of a predetermined cycle, and the light detection element 952 takes images of the target space. The image creating unit 954 obtains a distance to an object OBJ2 based on a phase difference in the modulation signals between light emitted from the emission source 951 to the target space and the light reflected from the object OBJ2 in the target space and received at the light detection element 952.

The photosensitive portions 9521 provided in the light detection element 952 have light receiving time periods, during which they receive the light from the target space, controlled by the control circuit portion 953. The photosensitive portions 9521 receives light in the light receiving time periods synchronized to different phases of the modulation signals. The light detection element 952 gives charges integrated for a detection time period which is a time period equal to or longer than one cycle of the modulation signals to the image creating unit 954. The image creating unit 954 obtains a distance using an amount of charges obtained by accumulating the charge amounts in a plurality of detection time periods for each of the light receiving periods.

FIG. 26 is a schematic diagram showing a distance detecting method of the distance estimating device 950 of Conventional Example 2.

In the distance estimating device 950 of Conventional Example 2, the phase amount of the receiving light signal is derived by sampling the light receiving signal (reflection wave) at a predetermined timing in synchronization with the modulation cycle of infrared light (illumination wave) with light intensity modulated to a sine wave y(t)=a×sin(2πt/T)+b and. Specifically, in the distance estimating device 950 of Conventional Example 2, sampling is performed at four points (for example, points A0, A1, A2, and A3 in FIG. 26) for one cycle of the modulation cycle, and a phase difference amount Ψ is derived from equation 4.

$$\begin{matrix}Equation 4 & \\ {A}_{0} = y ( 0 ) = A sin ( 0 - Ψ ) + B = - A sin Ψ + B \\ {A}_{1} = y ( T / 4 ) + A sin ( π / 2 - Ψ ) + B = A cos Ψ + B \\ {A}_{2} = y ( T / 2 ) = A sin ( π - Ψ ) + B = A sin Ψ + B \\ {A}_{3} = y ( 3 T / 4 ) = A sin ( 3 π / 2 - Ψ ) + B = - A cos Ψ + B \\ \frac{{A}_{2} - {A}_{0}}{{A}_{1} - {A}_{3}} = \frac{2 A sin Ψ}{2 A cos Ψ} = tan Ψ & \\ Ψ = {tan}^{- 1} ( \frac{{A}_{2} - {A}_{0}}{{A}_{1} - {A}_{3}} ) & ( 4 )\end{matrix}$$

In the distance estimating device 950 of Conventional Example 2, for the derivation process of the phase difference amount mentioned above, a special CCD imaging element, which has an integrated light receiving portion and modulating portion, is used. By modifying a method of driving the element, a distance detection process with a high numerical aperture is achieved. The distance estimating device 950 of Conventional Example 2 is small and has a high resolution, but has a disadvantage that the imaged picture (video) has low resolution and low frame rate.

### CITATION LIST

### Patent Literature

Patent Literature 1: Japanese Laid-Open Publication No. 2000-121339

Patent Literature 2: Japanese Laid-Open Publication No. 2006-84429

### SUMMARY

### Technical Problem

For improving the precision of distance images with the TOF system, it is considered to realize increasing the resolution of the distance images obtained by the distance estimating device by increasing the light detection elements in the distance estimating device. However, with such a method, an amount of light which impinges upon each of photosensitive portions forming the light detection element (reflected light) becomes small (an impinging light amount for each of pixels of an imaging element (CCD or the like) becomes small). Accordingly, a signal level of a signal obtained from the photosensitive portions forming the light detection element becomes small.

Further, random noise (shot noise) Ss included in charge amounts corresponding to photoelectric effect (shot noise Ss generated due to photoelectric conversion) is proportional to a charge amount Ns to the power of ½. Thus, when an amount of light impinging upon each of the pixels of an imaging element (CCD or the like) decreases, a rate of the noise (shot noise) included in the charge amounts obtained from the pixels of the imaging element increases. In other words, as the amount of light impinging upon each of the pixels of the imaging element (CCD or the like) decreases, S/N ratio of the signal obtained from the pixels of the imaging elements reduces. As a result, the distance sensitivity deteriorates.

The following measures are considered for such problem.

(1) To increase the emission amount of an LED (light source for the illumination light).

(2) To increase a detection time period for charges (one cycle or longer) to increase photo charge amounts secured at each of the pixels of the imaging element.

When these measures are taken, the integrated charge amounts of the pixels of the imaging element increase. In such case, the shot noise also increases in accordance with the principle as described above. However, the ratio SN=Ns/Ss between the charge amounts Ns (charge amounts obtained by photo electric conversion of the light reflected from the object (charge amounts of signal components)) and shot noise Ss increases as the charge amount Ns increases.

In the charge amounts integrated at each of the pixels of the imaging element, environment light and the like becomes a stationary noise which does not depend on the charge amounts by being photo-electrically converted at the imaging element. S/N ratio of the charge amounts is determined by the charge amount Ns (charge amount of a signal component), a shot noise Ss which is proportional to the charge amount Ns to the power of ½, and a stationary noise which corresponds to the environment light and/or the like. Accordingly, as the charge amount Ns increases, the S/N ratio of the charge amount becomes better and the S/N of the signal obtained at the imaging element becomes better. As a result, the distance resolution in the distance measurement of the distance estimating device improves.

However, since the stationary noise such as the environment light and the like has far larger value than the charge amount of the reflected light (charge amount Ns). Therefore, if the emission amount of the light source of the distance estimating device is increased, saturation may readily occur in each of the pixels of the imaging element (CCD or the like). Also, there is a problem of constraints in practical use (scale, power, and the like).

Further, if the charge accumulation time periods at each of the pixels of the imaging element (CCD or the like) are extended, the stationary noise component becomes large. Accordingly, S/N ratio of the charge amounts integrated at the pixels becomes small, and a small amount of signal component (corresponding to the charge amount Ns) exist in a large amount of noise component.

Still further, there is a limit in the capacity for integrating charges at each of the pixels (photosensitive portions) of the imaging element which form the light detection element. Thus, possibility that saturation occur increases. When saturation occurs at the light detecting element, the received light amount of the photosensitive portion is no longer relative to the light with the light intensity being modulated. Thus, it becomes impossible to accurately obtain the distance based on the signal obtained from the pixel corresponding to such a photosensitive portion.

In view of the above-described problems, an object of the present invention is to achieve a distance estimating device, a distance estimating method, program and an integration circuit which restrict saturation at imaging elements (CCDs and the like) from occurring, use a TOF system to obtain a distance image with a high resolution and a high frame rate, and performs a distance estimating process with a high precision.

### Solution to Problem

The first invention is a distance estimating device for irradiating an object with light having a light intensity being modulated and estimating a distance to the object using light reflected from the object, comprising a light source, an emission source, an emission frequency selecting unit, a light receiving optical system, a light receiving element unit, a charge integrating unit, a signal computing unit, and an image creating unit.

The light source emits light of which a light intensity can be modulated. The emission source control unit controls the light source. The emission frequency selecting unit determines a frequency of light to be emitted from the light source. The light receiving optical system condenses light from the object. The light receiving element converts light received at the light receiving optical system into charges. The charge integrating unit integrates charges acquired at the light receiving element unit and acquire a charge signal. The signal computing unit calculates distance information based on the charge signal. The image creating unit creates a distance image based on the distance information.

At an emission frequency selection mode: the emission source control unit controls the light source not to emit light; the emission frequency selecting unit obtains a frequency spectrum of the charge signal acquired by the charge integrating unit and determines a certain frequency of a frequency band with small frequency component in the frequency spectrum as an optimum emission frequency; and the emission control unit sets the emission frequency of the light source to the optimum emission frequency.

At a distance image obtaining mode: the emission source control unit has the light source emit light using the optimum frequency; the charge integrating unit acquires the charge signal from the light received with the light source emitting light using the optimum frequency; the signal computing unit calculates the distance information based on the charge signal obtained from the light received with the light source emitting light using the optimum frequency; and the image creating unit creates the distance image based on the distance information calculated based on the charge signal acquired from the light received with the light source emitting light using the optimum frequency.

In this distance estimating device, light reflected from the object with no light emitted from the light source is received. Based on the frequency analysis (spectrum analysis) of the reflected light, the object is irradiated with the light (electromagnetic waves) of the emission frequency insusceptible to the environment light, and the charge signal is obtained from the light reflected from the object. The distance image is obtained from the charge signal. In sum, the distance image can be obtained based on the charge signal insusceptible to the environment light component.

As a result, with such a distance estimating device, occurrence of saturation of the imaging elements (such as CCDs) can be suppressed, a distance image with a high resolution and a high frame rate can be obtained by using the TOF system, and a distance estimating process with high precision can be performed.

The second invention is the first invention, in which: the light source includes a plurality of emission sources having different emission frequencies; and the emission source control unit selects an emission source having the emission frequency closest to the optimum emission frequency from the plurality of emission sources and controls the selected emission source to emit light at the distance image obtaining mode.

With such a structure, a distance estimating device of a high precision can be readily achieved using a plurality of light sources.

Herein, “emission frequency” refers to a frequency of light (electromagnetic waves).

The third invention is the second invention, in which the plurality of light sources emit light of a frequency of an infrared region.

With such a structure, a distance estimating device of can be achieved using infrared light LED light sources of a reasonable price or the like as a plurality of light sources.

The fourth invention is any one of first through third inventions, further comprising a color separation prism, an imaging element unit, an image creating unit, and an in-object region charge extracting unit.

The color separation prism separates the light received at the light receiving optical system into light of visible light component and light of infrared light component. The imaging element unit converts the light of the visible light component which is separated by the color separation prism into a charge signal for image creation; an object region extracting unit. The image creating unit creates an image from the charge signal for image creation which is converted by the image element unit. The object region extracting unit extracts a certain image region in the image created by the image creating unit as an object region. The in-object region charge extracting unit extracts only the charge signal corresponding to the object region among the charge signal acquired by the charge integrating unit. The emission frequency selecting unit obtains a frequency spectrum of the charge signal acquired by the in-object region charge extracting unit and determines a certain frequency of a frequency band with small frequency component in the frequency spectrum as an optimum emission frequency.

In such a distance estimating device, a certain object region is extracted from a color image obtained from the light of visible light component. A frequency analysis (spectrum analysis) of the reflected light within the region corresponding to the object region extracted from (color) image in the distance image data obtained with the light reflected from the object is received with no light being emitted from the light source is performed. In such a distance estimating device, the distance estimating process is performed with the illumination light of the emission frequency insusceptible to the environment light based on the spectrum analysis result for the object region, and the distance image is obtained.

With such a structure, the distance estimating process can be performed by using illumination light which has less influence on the distance precision of the object region to be focused in this distance estimating device. Thus, a distance image with higher precision can be obtained at the object region to be focused.

The fifth invention is the fourth invention, in which the object region extracting unit has an image region of a face as the object region.

The sixth invention is the fourth invention, in which the object region extracting unit has an image region of people as the object region.

The seventh invention is the fourth invention, in which the object region extracting unit has an image region specified by a user as the object region.

The eighth invention is the fourth invention, in which the object region extracting unit treats the image created by the image creating unit with a region separating process, and has an image region separated to large regions as the object region.

The ninth invention is the eighth invention, in which the object region extracting unit performs the region separating process by grouping pixels forming the image based on brightness and color information.

The tenth invention is the eighth invention, in which the object region extracting unit performs the region separating process by performing a block separating process within image in the image created by the image creating unit, and grouping the image blocks based on average brightness information and/or average color information within the separated image blocks.

The eleventh invention is a distance estimating device for irradiating an object with light having a light intensity being modulated and estimating a distance to the object using light reflected from the object, comprising a light source, an emission source control unit, a light receiving optical system, a light receiving element unit, a charge integrating unit, a signal computing unit, an image creating unit, a multiple image storage memory unit, an optimum distance image selecting unit, a color separation prism, an imaging element unit, an image creating unit, an object region extracting unit, and an in-object region charge extracting unit.

The light source emits light of which a light intensity can be modulated. The emission source control unit controls the light source. The light receiving optical system condenses light from the object. The light receiving element unit converts light received at the light receiving optical system into charges. The charge integrating unit integrates charges acquired at the light receiving element unit and acquire a charge signal. The signal computing unit operable to calculate distance information based on the charge signal. The image creating unit creates a distance image based on the distance information. The multiple image storage memory unit stores the distance image created by the image creating unit for a multiple number. The optimum distance image selecting unit selects an optimum distance image from the distance image of a multiple number stored in the multiple image storage memory unit. The color separation prism separates the light received at the light receiving optical system into light of visible light component and light of infrared light component. The imaging element unit converts the light of the visible light component which is separated by the color separation prism into a charge signal for image creation. The image creating unit creates an image from the charge signal for image creation which is converted by the image element unit. The object region extracting unit extracts a certain image region in the image created by the image creating unit as an object region. The in-object region charge extracting unit extracts only the charge signal corresponding to the object region among the charge signal acquired by the charge integrating unit.

The emission source control unit controls the light source to irradiate the object with light having different emission frequencies. The multiple image storage memory unit stores a multiple number of the distance image created by irradiating the object with light having different emission frequencies from the light source. The optimum distance image selecting unit selects an optimum distance image from the multiple number of distance image by evaluating the image data within the object region set by the object region extracting unit based on a predetermined reference among the multiple number of distance image stored in the multiple image storage memory.

In such a distance estimating device, a pixel value distribution in the distance image corresponding to the object region extracted from (color) image is obtained for the distance image data created with light of a plurality of frequencies, and the distance image data indicating an appropriate pixel value distribution based on the obtained pixel value distributions is selected. In other words, in such a distance estimating device, the distance image by the light source of illumination light having emission frequency insusceptible to the environment light in the object region to be focused can be obtained. Thus, a distance image with a high precision can be obtained at the region which draws high attention in the image can be obtained.

The twelfth invention is the eleventh invention, in which the light source includes a plurality of emission sources having different emission frequencies.

The thirteenth invention is the twelfth invention, in which the plurality of light sources emit light of a frequency of an infrared region.

The fourteenth invention is a distance estimating method for irradiating an object with light having a light intensity being modulated and estimating a distance to the object using light reflected from the object, the distance estimating method used in a distance estimating device comprising a light source, a light receiving optical system, a light receiving element unit, and a charge integrating unit, and the method comprising emission controlling, emission frequency selecting, signal computing, and image creating.

The light source emits light of which a light intensity can be modulated. The light receiving optical system condenses light from the object. The light receiving element unit converts light received at the light receiving optical system into charges. The charge integrating unit integrates charges acquired at the light receiving element unit and acquires a charge signal.

In the step of emission source controlling, the light source is controlled. In the step of emission frequency selecting step, a frequency of light emitted from the light source is determined. In the step of signal computing, distance information is calculated based on the charge signal. In the step of image creating, a distance image is created based on the distance information.

At an emission frequency selection mode: the emission source control unit controls the light source not to emit light; in the step of emission frequency selecting, frequency spectrum of the charge signal acquired by the charge integrating unit is obtained and a certain frequency of a frequency band with small frequency component in the frequency spectrum is determined as an optimum emission frequency; and in the step of emission controlling, the emission frequency of the light source is set to the optimum emission frequency. At a distance image obtaining mode: in the step of emission source controlling, the light source emit light using the optimum frequency; in the step of signal computing, the distance information is calculated based on the charge signal obtained from the light received with the light source emitting light using the optimum frequency; and in the step of image creating, the distance image is created based on the distance information calculated based on the charge signal acquired from the light received with the light source emitting light using the optimum frequency.

With such a structure, a distance estimating method having effects similar to those of the first invention can be achieved.

The fifteenth invention is a program for operating computer to run a distance estimating method for irradiating an object with light having a light intensity being modulated and estimating a distance to the object using light reflected from the object, the distance estimating method used in a distance estimating device comprising a light source, a light receiving optical system, a light receiving element unit, and a charge integrating unit, the method comprising emission source controlling, emission frequency selecting, signal computing, and image creating.

The light source emits light of which a light intensity can be modulated. The light receiving optical system condenses light from the object. The light receiving element unit converts light received at the light receiving optical system into charges. The charge integrating unit integrates charges acquired at the light receiving element unit and acquires a charge signal. In the step of emission source controlling, the light source is controlled. In the step of emission frequency selecting, a frequency of light is determined to be emitted from the light source. In the step of signal computing, distance information is calculated based on the charge signal. In the step of image creating, a distance image is created based on the distance information.

At an emission frequency selection mode: the emission source control unit controls the light source not to emit light; in the step of emission frequency selecting, frequency spectrum of the charge signal acquired by the charge integrating unit is obtained and a certain frequency of a frequency band with small frequency component in the frequency spectrum is determined as an optimum emission frequency; and in the step of emission controlling, the emission frequency of the light source is set to the optimum emission frequency. At a distance image obtaining mode, in the step of emission source controlling, the light source emit light using the optimum frequency; in the step of signal computing, the distance information is calculated based on the charge signal obtained from the light received with the light source emitting light using the optimum frequency; and in the step of image creating, the distance image is created based on the distance information calculated based on the charge signal acquired from the light received with the light source emitting light using the optimum frequency.

With such a structure, a program having effects similar to those of the first invention can be achieved.

The sixteenth invention is an integrated circuit for a distance estimating device for irradiating an object with light having a light intensity being modulated and estimating a distance to the object using light reflected from the object, the integrated circuit used for the distance estimating device comprising: a light source, a light receiving optical system, an emission source control unit, an emission frequency selecting unit, a light receiving element unit, a charge integrating unit, a signal computing unit, and an image creating unit.

The light source emits light of which a light intensity can be modulated. The light receiving optical system condenses light from the object. The emission source control unit controls the light source. The emission frequency selecting unit determines a frequency of light to be emitted from the light source. The light receiving element unit converts light received at the light receiving optical system into charges. The charge integrating unit integrates charges acquired at the light receiving element unit and acquires a charge signal. The signal computing unit calculates distance information based on the charge signal. The image creating unit creates a distance image based on the distance information.

At an emission frequency selection mode: the emission source control unit controls the light source not to emit light; the emission frequency selecting unit obtains a frequency spectrum of the charge signal acquired by the charge integrating unit and determines a certain frequency of a frequency band with small frequency component in the frequency spectrum as an optimum emission frequency; and the emission control unit sets the emission frequency of the light source to the optimum emission frequency. At a distance image obtaining mode, the emission source control unit has the light source emit light using the optimum frequency; the charge integrating unit acquires the charge signal from the light received with the light source emitting light using the optimum frequency; the signal computing unit calculates the distance information based on the charge signal obtained from the light received with the light source emitting light using the optimum frequency; and the image creating unit creates the distance image based on the distance information calculated based on the charge signal acquired from the light received with the light source emitting light using the optimum frequency.

With such a structure, an integrated circuit having effects similar to those of the first invention can be achieved.

The seventeenth invention is a camera including a distance estimating device according to any one of the first through thirteenth inventions.

With such a structure, a camera with a distance estimating device having effects similar to those of the first invention can be achieved.

The term “camera” encloses a still camera for obtaining still images, an imaging device (camcoder) for obtaining motion pictures, an imaging device which can take both still image and video, and an imaging device having a function to create a 3D display image (picture) from the obtained imaged pictures (pictures).

Further, in the camera of the seventeenth invention, image pictures may be obtained by using the high-resolution images created by the high-resolution image creating unit of the distance measuring device included in the camera, or an imaging element may be further added to the distance measurement device, and the image pictures may be obtained from the added imaging element.

### ADVANTAGEOUS EFFECTS

According to the present invention, a distance estimating device, a distance estimating method, a program, an integrated circuit and a camera, in which occurrence of saturation in the imaging elements (CCDs and the like) is suppressed, and which can obtain distance images of a high resolution and a high frame rate by using the TOF system and perform the distance estimating process of a high precision, can be achieved.

### BRIEF DESCRIPTION OF DRAWINGS

FIG. 1 is a schematic diagram of a distance estimating device according to the first embodiment of the present invention.

FIG. 2 is a schematic diagram of an emission frequency selecting unit according to the first embodiment of the present invention.

FIG. 3 is a diagram showing an outline of an outline of a method for selecting an emission frequency of a light source in the distance estimating method according to the first embodiment of the present invention.

FIG. 4 is a diagram showing a relationship between a spectrum analysis and the emission frequency to be selected in the distance estimating method according to the first embodiment of the present invention.

FIG. 5 is a flow diagram of the distance estimating method according to the first embodiment of the present invention.

FIG. 6 is a schematic diagram of a distance estimating device according to the second embodiment of the present invention.

FIG. 7 is a schematic diagram showing an outline of a method for selecting an emission frequency in a distance estimating method according to the second embodiment of the present invention.

FIG. 8 is a flow diagram of the distance estimating method according to the second embodiment of the present invention.

FIG. 9 is a diagram showing a summary of pattern matching in the distance estimating device according to the second embodiment of the present invention.

FIG. 10 is a block diagram showing an object region extracting unit 14 in the distance estimating device according to the second embodiment of the present invention.

FIG. 11 is a block diagram showing an object region extracting unit 14A in the distance estimating device according to the second embodiment of the present invention.

FIG. 12 is a block diagram showing an object region extracting unit 14B in a distance estimating device according to the third embodiment of the present invention.

FIG. 13 showing a summary of a separating method at the object region extracting unit in the distance estimating device according to the third embodiment of the present invention.

FIG. 14 is a schematic diagram showing detection of a candidate region in the distance estimating device according to the third embodiment of the present invention.

FIG. 15 is a block diagram showing an object region extracting unit 14C in the distance estimating device according to the third embodiment of the present invention.

FIG. 16 is a block diagram showing an object region extracting unit 14D in a distance estimating device according to the fourth embodiment of the present invention.

FIG. 17 is a flow diagram of a distance estimating method according to the fourth embodiment of the present invention.

FIG. 18 is a diagram illustrating an image separation at an image separating portion in a distance estimating device according to the fourth embodiment of the present invention.

FIG. 19 is a block diagram showing an object region extracting unit 14E in the distance estimating device according to the fourth embodiment of the present invention.

FIG. 20 is a schematic diagram of a distance estimating device according to the fifth embodiment of the present invention.

FIG. 21 is a schematic diagram showing a process of an optimum distance image selecting unit in the distance estimating device according to the fifth embodiment of the present invention.

FIG. 22 is a flow diagram of a distance estimating method according to the fifth embodiment of the present invention.

FIG. 23 is a block diagram showing a distance estimating device of Conventional example 1.

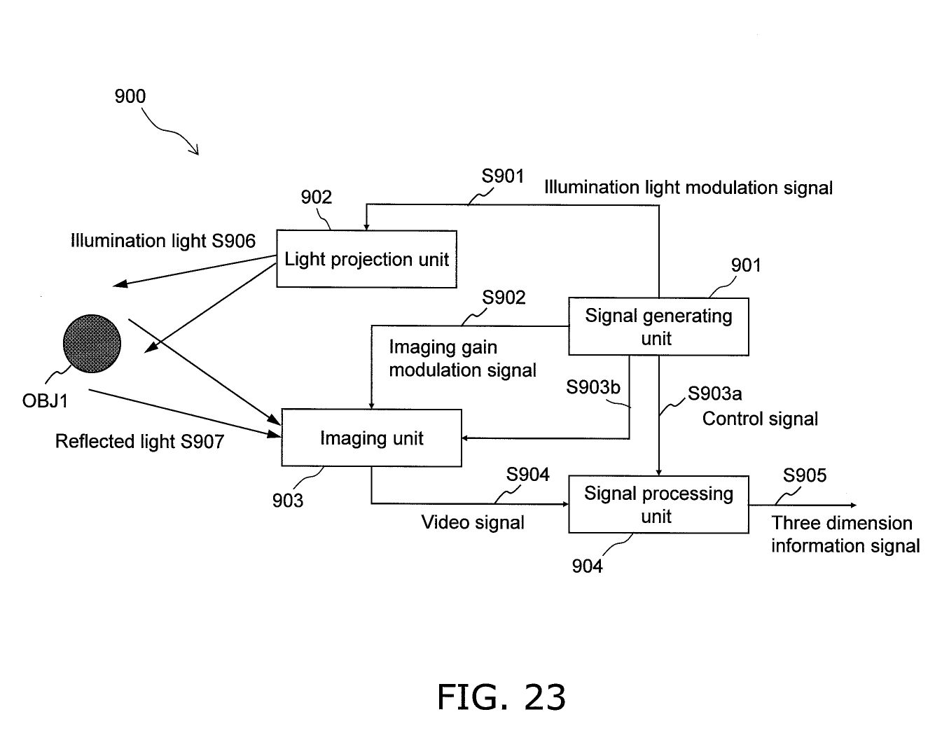

FIG. 24 is a diagram showing an outline of a distance estimating device of Conventional example 1.

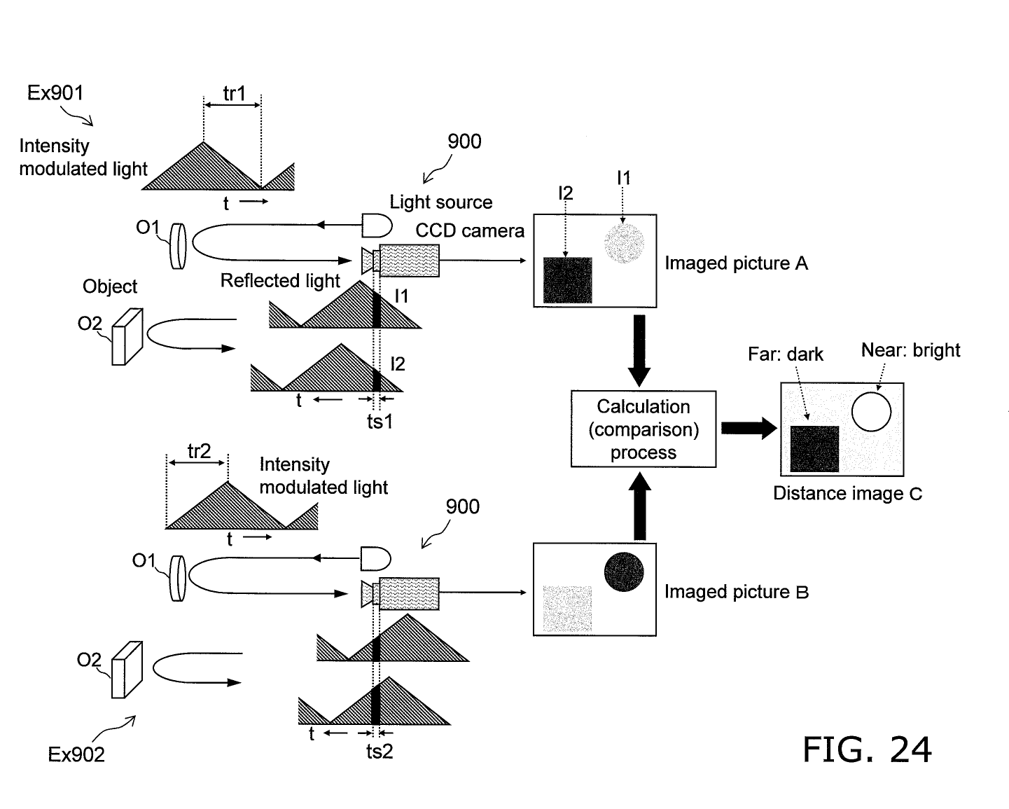

FIG. 25 is a block diagram showing a distance estimating device of Conventional example 2.

FIG. 26 is a diagram showing an outline of a distance estimating device of Conventional example 2.

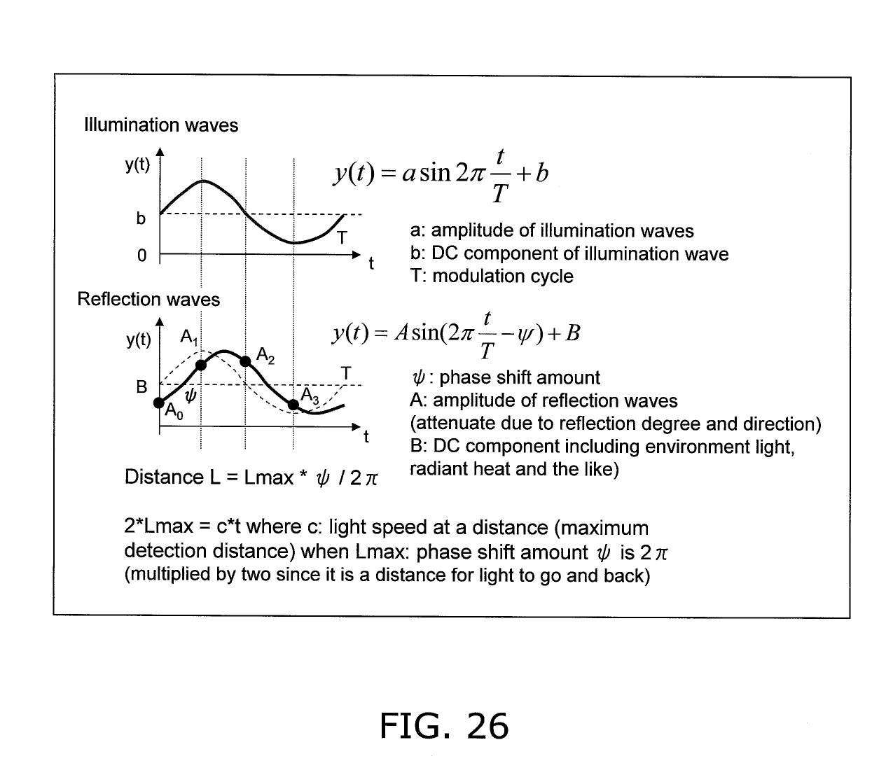

FIG. 27 is a diagram showing a relationship between a spectrum analysis with a wavelength being a horizontal axis and a selected infrared wavelength.

### DESCRIPTION OF EMBODIMENTS

Hereinafter, the first through fifth embodiments will be described as the best embodiments of the present invention.

In the first embodiment, a device and a method, in which light reflected from an object with no light emitting from a light source is received, illumination light having an emission frequency which is insusceptible to environment light is selected based on frequency analysis of the reflected light, and the illumination light having the selected emission frequency is used for obtaining a distance image to the object and estimating the distance, are described.

In the second embodiment, a device and a method, in which a predetermined object region is extracted from a color image obtained based on visible light components obtained by synchronization with reflected light of illumination light for distance estimating, illumination light having an emission frequency which is insusceptible to environment light is selected based on frequency analysis of the reflected light in a region corresponding to the object region extracted from the color image in distance image data obtained by receiving the reflected light off the object with no light emitting from a light source, and a distance image to the object is obtained by using the illumination light having the selected emission frequency, are described.

In the third embodiment, a distance estimating device and a method which are characterized in that regions are separated by grouping pixels based on brightness and color information when the object region is extracted in the second distance estimating method according to the present invention, are described.

In the fourth embodiment, a distance estimating device and a method which are characterized in that regions are separated by separating images into blocks and grouping the blocks based on average brightness and average color information of the blocks when the object region is extracted in the second distance estimating method according to the present invention, are described.

In the fifth embodiment, a distance estimating device and a method, in which a light source can emit light having a plurality of different emission frequencies, multiple distance image data sets obtained by a plurality of illumination lights having the emission frequencies are created, a predetermined object region is extracted from a color image obtained from visible light components obtained by synchronization with reflected light of the illumination light for distance estimation, pixel value distributions in distance images corresponding to the object region extracted from the color image are obtained with respect to the created distance image data sets for the illumination lights of the plurality of emission frequencies, and distance image data which shows an appropriate pixel value distribution is selected from the pixel value distributions in distance images in the object region for the illumination lights of the plurality of emission frequencies, are described.

### First Embodiment

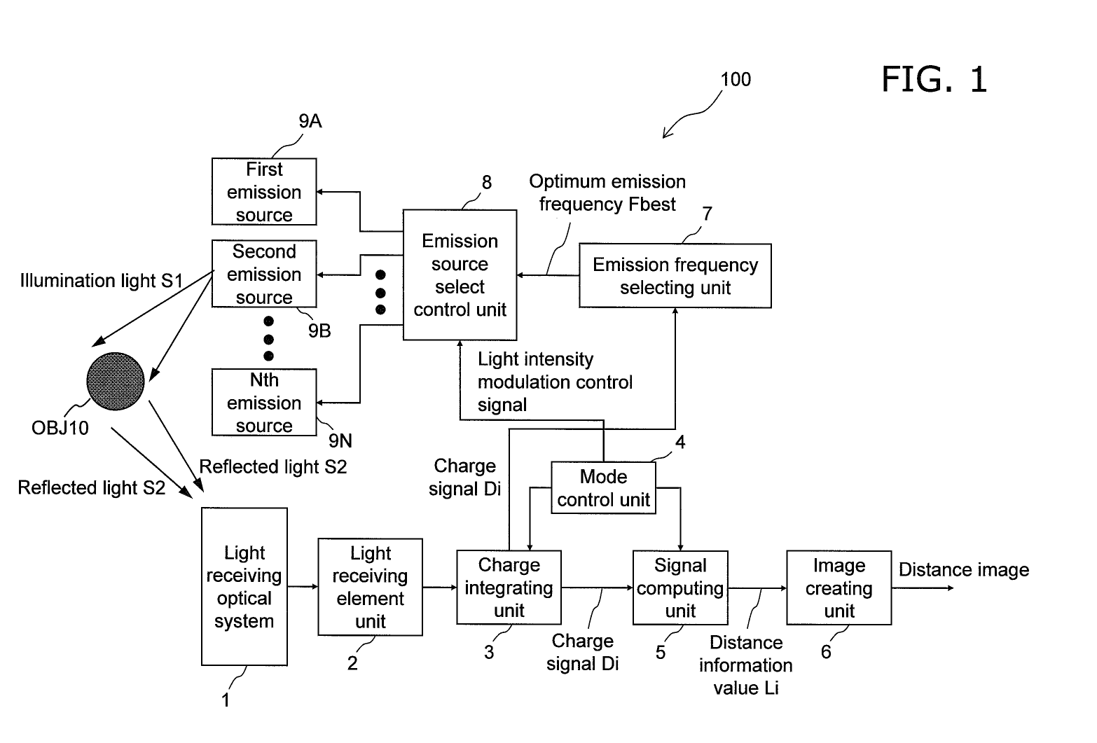

With reference to FIGS. 1 through 5, a distance estimating device and a distance estimating method, in which light reflected from an object with no light being emitted from the light source is received, illumination light having an emission frequency which is insusceptible to environment light is selected based on a result of a frequency analysis of the reflected light, and the illumination light having the selected emission frequency is used to obtain a distance image to the object, are described as the first embodiment of the present invention.

<1.1: Structure of a Distance Estimating Device>

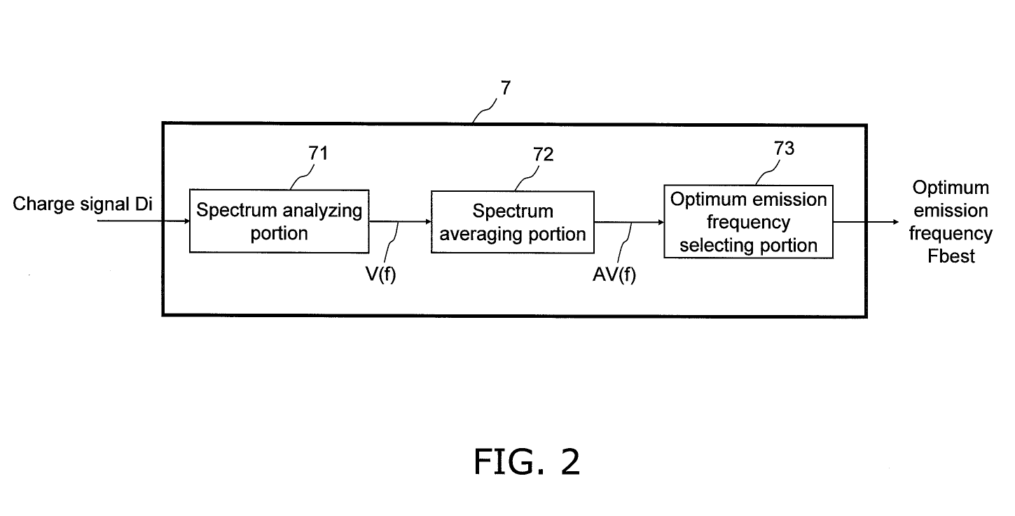

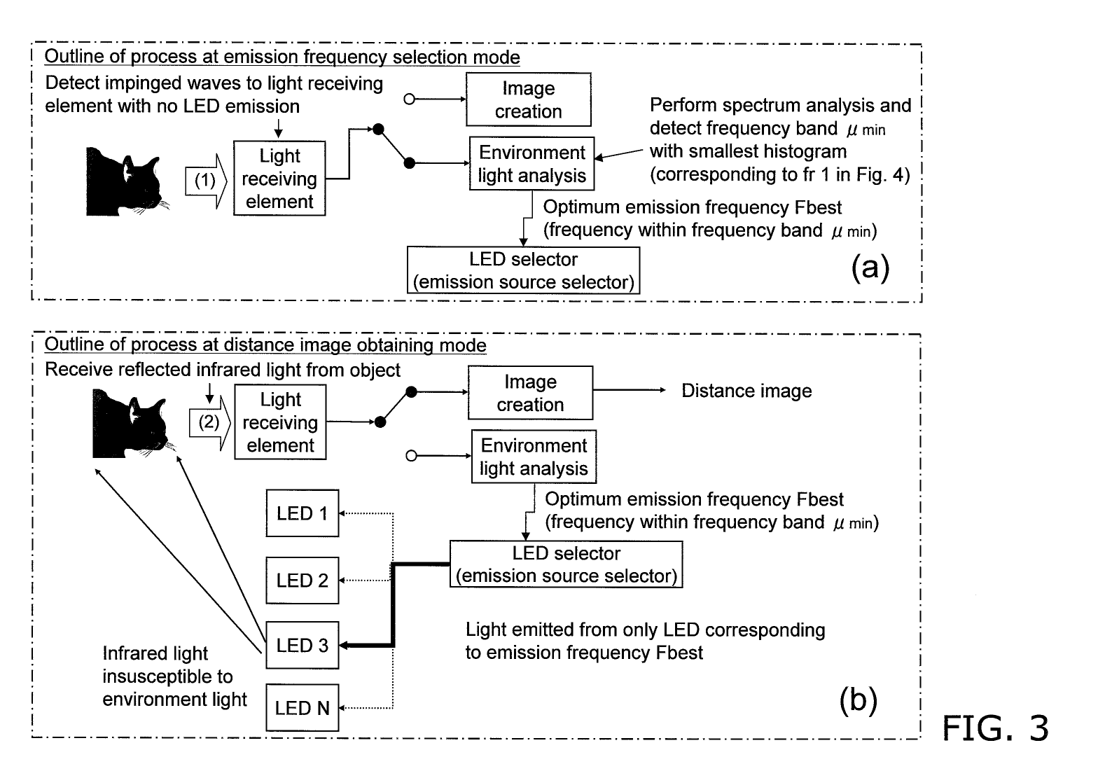

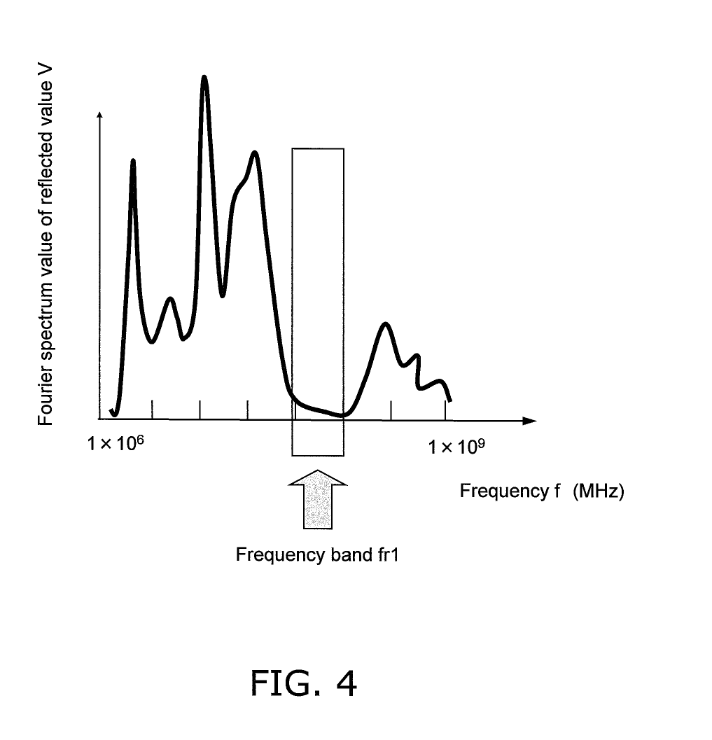

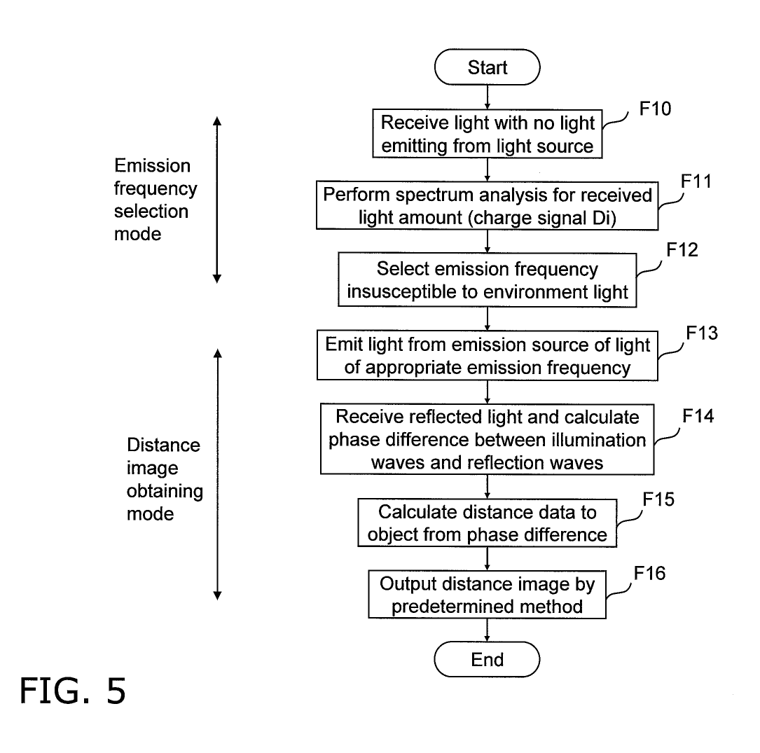

FIG. 1 is a schematic block diagram of a distance estimating device 100 according to the first embodiment of the present invention. FIG. 2 is a diagram showing a structure of an emission frequency selecting unit 7 in the distance estimating device which is an example of the first embodiment of the present invention. FIG. 3 is a diagram showing an outline of a method for selecting an emission frequency of a light source in the distance estimating method according to the first embodiment. FIG. 4 is a diagram showing a relationship between a spectrum analysis and the emission frequency to be selected in the distance estimating method according to the first embodiment. FIG. 5 is a flow diagram of the distance estimating method according to the first embodiment.

The distance estimating device of the present invention relates to a method and a device for imaging a target space and estimating a distance from an imaging device to an object existing in the target space in order to improve a sense of depth and a stereoscopic effect of an image taken by an imaging device such as camcorders, DSCs, and the like. The distance estimating device is incorporated into, for example, imaging equipment such as digital still cameras, digital video cameras and the like, devices for mobile use such as cell phones, car mobile equipment, PDAs and the like, and so on. The distance estimating method of the present invention is performed on the equipment mentioned above or the like.

As shown in FIG. 1, the distance estimating device 100 comprises a light receiving optical system 1 which condenses light from an object, a light receiving element unit 2 having an element for photoelectric conversion of the light condensed at the light receiving optical system (imaging element), and a charge integrating unit 3 which integrates charges converted at the light receiving element unit 2 and outputs as charge signals. The distance estimating device 100 further comprises an emission frequency selecting unit 7 which analyzes spectrum of the charge signals output from the charge integrating unit 3 and determines an optimum emission frequency, a emission source select control unit 8 which determines an emission source to actually emit light from a plurality of emission sources 9A through 9N based on the optimum emission frequency determined by the emission light frequency selecting unit 7, and the plurality of emission sources 9A through 9N (first emission source 9A, second emission source 9B, . . . , Nth emission source) (N: natural number) of which light emission is controlled based on control signals from the emission source select control unit 8.

The distance estimating device 100 also comprises a signal computing unit 5 which treats the charge signals output from the charge integrating unit 3 with a process of equation 4 to calculate distance information, a mode control unit 4 which controls the charge integrating unit 3 and a signal computing unit 5, and an image creating unit 6 which creates a distance image based on the distance information calculated by the signal computing unit 5.

The light receiving optical system 1 is an optical system which condenses light from an imaging target space, and is formed of an optical lens, an optical filter and the like.

The light receiving element unit 2 includes an imaging element comprising a plurality of pixels. Each of the pixels includes a photoelectric conversion element such as photodiode or the like. In the light receiving element unit 2, charges are acquired in accordance with the amount of received light which is photo-electrically converted at each of the pixels. The charges acquired at the light receiving element unit 2 are output to the charge integrating unit 3. If the light emitted from the plurality of emission sources 9A through 9N (first emission source 9A, second emission source 9B, . . . , Nth emission source) (N: natural number) is infrared light, it is preferable to use a CCD for infrared light as the imaging element of the light receiving element unit 2. Alternatively, a filter for infrared light (an optical filter) or the like may be provided in front of the imaging element of the light receiving element unit 2 in order to cut electromagnetic waves outside the infrared region.

The charge integrating unit 3 integrates charges which are subjected to photoelectric conversion at the light receiving element unit 2 based on a predetermined charge accumulation time set by the mode control unit 4, and acquires a charge signal Di. The charge integrating unit 3 outputs the acquired charge signal Di to the emission light frequency selecting unit 7 or the signal computing unit 5 based on an instruction of the mode control unit 4.

As shown in FIG. 2, the emission light frequency selecting unit 7 includes a spectrum analyzing portion 71, a spectrum averaging portion 72, and an optimum emission frequency selecting portion 73. The emission light frequency selecting unit 7 receives the charge signal Di from the charge integrating unit 3 as an input, and analyzes spectrum of the charge signal Di to determine the optimum emission frequency Fbest (details will be further described).

The spectrum analyzing portion 71 receives the charge signal Di from the charge integrating unit 3 as an input, and treats the charge signal Di with, for example, Fourier transform, to obtain spectrum V(f) of the charge signal Di. The spectrum analyzing portion 71 then outputs the obtained result V(f) of spectrum analysis for the charge signal Di to the spectrum averaging portion 72.

The spectrum averaging portion 72 receives the output V(f) from the spectrum analyzing portion 71 and treats the result V(f) of spectrum analysis for the charge signal Di obtained by the spectrum analyzing portion 71 with an averaging process (details will be further described). The spectrum averaging portion 72 then outputs a spectrum analysis result AV(f) treated with the averaging process to the optimum emission frequency selecting portion 73.

The optimum emission frequency selecting portion 73 receives the spectrum analysis result AV(f) from the spectrum averaging portion 72 as an input, and determines the optimum emission frequency Fbest based on the spectrum analysis result AV(f) (details will be further described). The optimum emission frequency selecting portion 73 outputs the determined optimum emission frequency Fbest to the emission source select control unit 8.

The emission source select control unit 8 is connected to the plurality of emission sources 9A through 9N and can control the plurality of emission sources 9A through 9N. The emission source select control unit 8 determines an emission source to actually emit light from the plurality of emission sources 9A through 9N based on the optimum emission frequency determined by the emission light frequency selecting unit 7, and controls light emission of the determined light source. More specifically, the emission source select control unit 8 selects a light source which emits light having a frequency closest to the optimum frequency from the plurality of emission sources 9A through 9N, and controls light emission of the selected light source. Further, the emission source select control unit 8 receives a light intensity modulation control signal output from the mode control unit 4 as an input and modulates the light intensity of the selected light source based on the light intensity modulation control signal.

The plurality of emission sources 9A through 9N (first emission source 9A, second emission source 9B, . . . , Nth emission source) (N: natural number) are emission sources which emit light having frequencies of different frequency bands, and are controlled emission of light based on control signals from the emission source select control unit 8. Herein, “different frequency bands” do not always have to mean the frequency bands completely different from each other, but also include frequency bands of the light emitted from the plurality of light sources, which partially overlap each other, for example. The plurality of emission sources 9A through 9N (first emission source 9A, second emission source 9B, . . . , Nth emission source) (N: natural number) are preferably light sources which emit electromagnetic waves (infrared light) of frequencies of infrared light region (for example, 1×10 ̂6 [MHz] . . . 1×10̂9 [MHz]) (“X̂Y” means “X to the power of Y”, the same is also true of the following descriptions). When frequencies of infrared light region are used, it is preferable to use LED light sources which emit light of frequencies of the infrared region.

The signal computing unit 5 treats a charge signal Di output from the charge integrating unit 3 with a process of, for example, Equation 4, and calculates distance information Li. A charge signal related to pixel i of the imaging element of the light receiving element unit 2 is denoted by Di, and the distance information related to the pixel i is denoted by Li. The signal computing unit 5 outputs the calculated distance information Li to the image creating unit 6.

The mode control unit 4 controls the charge integrating unit 3 and the signal computing unit 5. The mode control unit 4 controls in accordance with one of the modes, “emission frequency selection mode” and “distance image obtaining mode”, which are two modes of the distance estimating device 100. The “emission frequency selection mode” is a mode for process to determine the frequency of the light, with which the image target space is irradiated, for performing the distance estimating process in the distance estimating device 100. On the other hand, the “distance image obtaining mode” is a mode for obtaining the distance information by irradiating the image target space with the light of the frequency determined at the “emission frequency selection mode” and obtaining the distance image based on the obtained distance information in the distance estimating device 100.

When the mode of the distance estimating device 100 is the “emission frequency selection mode”, the mode control unit 4 controls the charge integrating unit 3 such that the charge signal Di output from the charge integrating unit 3 is output to the emission light frequency selecting unit 7.

On the other hand, when the mode of the distance estimating device 100 is “distance image obtaining mode”, the mode control unit 4 outputs the light intensity modulation control signal to the emission source select control unit 8, and modulates the intensity of the light emitted from the light source selected by the emission source select control unit 8 based on the light intensity modulation control signal. Then, the mode control unit 4 has the charge integrating unit 3 obtain the integrated charge amount at a predetermined timing in synchronization with the modulation cycle of illumination light S1 of which the light intensity is modulated based on the light intensity modulation control signal and output as the charge signal Di to the signal computing unit 5. Then, the mode control unit 4 controls the signal computing unit 5 to perform a process which corresponds to Equation 4, for example.

Herein, the “predetermined timing” refers to timing corresponding to sampling four points (corresponding to, for example, point A0 through point A4 in the above Equation 4) for one cycle of the modulation cycles of the illumination light S1 of which the light intensity is modulated based on the light intensity modulation control signal, for example. It is needless to mention that the number of sampling for one cycle of the modulation cycles of the illumination light S1 is not limited to four.

When the number of sampling for one modulation cycle of the illumination light S1 is four, the signal computing unit 5 treats the charge signal Di output from the charge integrating unit 3 with a process corresponding to Equation 4 to obtain a phase difference amount ψ, and then, can readily obtain the distance information Li.

The image creating unit 6 receives the distance information Li calculated by the signal computing unit 5 as an input, and creates the distance image based on the distance information Li. Herein, the “distance image” means a two dimensional image which corresponds to the pixel i of the imaging element of the light receiving element unit 2, and a value of a point on the distance image, which corresponds to the pixel i, is a value representing the distance information which corresponds to pixel i. In other words, the value of the point on the distance image, which corresponds to the pixel i, is a value representing a distance between the object in the image target space, which corresponds to pixel i and the distance estimating device 100 (this value does not always have to be the value of the distance itself, but may be the value which is correlated to the distance).

<1.2: Operation of the Distance Estimating Device>

With reference to FIGS. 1 through 5, operations of the distance estimating device 100 having the structure as described above and a distance estimating method performed by the distance estimating device 100 will be described. The descriptions will be made separately for “emission frequency selection mode” and “distance image obtaining mode”.

(1.2.1: Emission Frequency Selection Mode)

First, the “emission frequency selection mode” is described.

In the distance estimating device 100, all of the plurality of emission sources 9A through 9N are stopped emitting light. In such a state, light from the object OBJ10 passes through the light receiving optical system 1 and impinges upon the light receiving element unit 2. Charges acquired by photoelectric conversion at pixels of the imaging element of the light receiving element unit 2 are output to the charge integrating unit 3.

The charge integrating unit 3 integrates charge signals acquired from the reflected light S2 to acquire the charge signal Di. The charge integrating unit 3 integrates charges for a predetermined time period set by the mode control unit 4 and acquires the charge signal Di. The mode control unit 4 controls such that the charge integrating unit 3 outputs the charge signal Di to the emission frequency selecting unit 7.

In such a way, the charge signal Di is input to the emission frequency selecting unit 7.

In the emission frequency selecting unit 7, the charge signal Di is first treated with spectrum analysis by the spectrum analyzing portion 71.

Specifically, the spectrum analyzing portion 71 treats the charge signal Di of the reflected light S2 with Fourier transform as shown in Equation 5 (hereinafter, the case where Fourier transform is used is described although discrete cosine transform, wavelet transform or the like may be used instead of Fourier transform). Power spectrum amount V(f) which indicates the size of the Fourier transform coefficient for the obtained frequencies f [Hz] is obtained. FIG. 4 shows an example of the spectrum V obtained from the charge signal Di by the spectrum analyzing portion 71.

$$\begin{matrix}Equation 5 & \\ V [ f ] = {\sum }_{k = 0}^{N - 1} {D}_{k} \cdot {W}_{N}^{if} , \\ ( f = 0 , 1 , … , N - 1 ) \\ {W}_{N} = {e}^{- j \frac{2 π}{N}} & ( 5 )\end{matrix}$$

The spectrum V obtained in such a way is output to the spectrum averaging portion 72.

The spectrum averaging portion 72 treats the spectrum V with a movement averaging process. For example, the spectrum averaging portion 72 treats the spectrum V as shown in FIG. 4 with a movement averaging process for the frequency f as shown by Equation 6. The movement averaging process is, as shown in Equation 6, for obtaining a weighted average value AV (f) with the weight coefficient w(f) being used for the spectrum V(f) in the range of [−df+f,f+df] having the object frequency f as a center. An example of the weight coefficient w(f) is one using gaussian distribution function having the object frequency fc as a center as shown in Equation 6. The weight coefficient w(f) may use functions such as rectangular function, trigonometric function, or the like instead of the gaussian distribution function.

$$\begin{matrix}Equation 6 & \\ AV [ fc ] = 1 / Total W \cdot {\sum }_{f = fc - df}^{fc + df} w [ f ] \cdot V [ f ] , \\ ( f = 0 , 1 , … , N - 1 ) \\ w [ f ] = exp ( - {( fc - f )}^{2} / Df ) \\ Total W = {\sum }_{f = fc - df}^{fc + df} w [ f ] & ( 6 )\end{matrix}$$

An object of process herein is to obtain a variation in the spectrum amount V(f) in general in order to mitigate influence of noise during measurement.

Instead of Equation 6, a method in which window function hwN is provided at Fourier transform as in Equation 7 and is used for weight in obtaining sum in Equation 5 may be employed.

$$\begin{matrix}Equation 7 & \\ {hw}_{N} = \{ \begin{matrix}1 / 2 \cdot ( 1 - cos \frac{2 π n}{M} ) , & 0 \leq n \leq M - 1 \\ 0 , & others\end{matrix} & ( 7 )\end{matrix}$$

The averaging spectrum AV (f) obtained in such a way by the spectrum averaging portion 72 is input to the optimum emission frequency selecting portion 73.

The optimum emission frequency selecting portion 73 calculates a frequency fmin at which AV(f) has the smallest value based on the input averaging spectrum AV (f). The optimum emission frequency selecting portion 73 determines the frequency of the light source having the emission frequency closest to fmin from the emission frequencies sf_k (K=1, . . . , N) of the light sources of the N number from the first emission source 9A through the Nth emission source 9N as the optimum emission frequency Fbest. The emission frequencies sf_k (K=1, . . . , N) of the light sources of the N number from the first emission source 9A through the Nth emission source 9N are previously known.

The optimum emission frequency Fbest determined in such a way is a frequency of a frequency band which is not included in the environment light much. Therefore, the distance estimating device 100 can mitigate influence of the environment light by using the light (electromagnetic waves) of the optimum emission frequency Fbest for performing the distance estimating process.

In the case of the spectrum V(f) as shown in FIG. 4, a frequency component of the frequency band fr is small, and thus, it can be estimated that the environment light does not contain the frequency component of the frequency band fr much. In such a case, in the distance estimating device 100, the optimum emission frequency Fbest is determined to be the frequency within the frequency band fr, and the distance estimating process is performed with light (electromagnetic waves) of the determined frequency. In this way, influence by the environment light can be reduced.

Further, a method for determining the optimum emission frequency Fbest determined at the emission light frequency selecting unit 7 may be as follows.

(1) First, a minimum value AV (fmin) of the averaging spectrum is compared with a predetermined threshold value TH1.

(2) When the minimum spectrum AV (fmin) of the averaging spectrum AV(f) is smaller than the predetermined threshold value TH1, the frequency of the light source having the emission frequency closest to fmin among the emission frequencies sf_k (K=1, . . . , N) of the light sources of the N number is determined to be the optimum emission frequency Fbest.

(3) On the other hand, when the minimum spectrum AV (fmin) of the averaging spectrum AV(f) is equal to or larger than the predetermined threshold value TH1, it is estimated that there are large number of frequency candidates which has small influence on the environment light (candidates of frequencies which include small amount of spectrum included in the environment light). Thus, an average value of the frequency f which satisfies:

|AV(f)−TH1|<Delta(Delta: predetermined positive constant)

is obtained as fmin_ave. Then, the frequency of the light source having the emission frequency closest to fmin_ave among the emission frequencies sf_k (K=1, . . . , N) of the light sources of the N number, which has been prepared previously, is determined to be the optimum emission frequency Fbest.

The optimum emission frequency Fbest determined at the emission light frequency selecting unit 7 is output to the emission source select control unit 8 as described above.

(1.2.2: Distance Image Obtaining Mode)

Next, the “distance image obtaining mode” is described.

At the distance image obtaining mode, light emission of the light source having the optimum emission frequency Fbest determined at the “emission frequency selection mode” is controlled by the emission source select control unit 8. Also, the light intensity modulation signal is input to the emission source select control unit 8 from the mode control unit 4.

The emission source select control unit 8 controls light emission of the selected light source, i.e., the light source which emits light (electromagnetic waves) of which the frequency is the optimum emission frequency Fbest, based on the light intensity modulation signal. Specifically, the intensity of the light emitted from the light source is modulated based on the light intensity modulation signal.

The object OBJ10 is irradiated with the illumination light S1 emitted from the selected light source (the illumination light S1 of which the frequency is the optimum emission frequency Fbest). The reflected light S2 is condensed at the light receiving optical system 1 and impinges upon the light receiving element unit 2.

In the light receiving element unit 2, the reflected light S2 is subjected to photoelectric conversion and acquired as charges at each of the pixels.

The charges acquired at the light receiving element unit 2 are integrated by the charge integrating unit and are output as the charge signals Di to the signal computing unit 5. More specifically, in accordance with the instruction from the mode control unit 4, a charge amount integrated at the charge integrating unit 3 is acquired at a predetermined timing in synchronization with the modulation cycle of the illumination light S1 which has the light intensity being modulated based on the light intensity modulation control signal, and is output to the signal computing unit 5 as a charge signal Di. Herein, the “predetermined timing” refers to timing corresponding to sampling four points (corresponding to, for example, point A0 through point A4 in the above Equation 4) for one cycle of the modulation cycles of the illumination light S1 of which the light intensity has been modulated based on the light intensity modulation control signal, for example. Hereinafter, the case where the number of sampling for one cycle of the modulation cycles of the illumination light S1 is four will be described for the sake of simplicity in explanation.

The signal computing unit 5 treats the input charge signal Di (the charge signal Di which is sampled at four points for one modulation cycle of the illumination light S1) with the process corresponding to Equation 4 to obtain the phase difference amount ψ. Further, the signal computing unit 5 treats the phase difference amount ψ with a process corresponding to Equation 3 to obtain the distance information Li for the pixel i.

The distance information Li obtained by the signal computing unit 5 is output to the image creating unit 6.

The image creating unit 6 creates a distance image based on the distance information Li calculated by the signal computing unit 5.

In sum, in the distance estimating device 100, the reflected light S2 is received at the light receiving element unit 2, and the charge signal Di converted and integrated by the light receiving element unit 2 and the charge integrating unit 3 is controlled by the mode control unit 4 and is converted into a distance information value Li for the corresponding pixel i by the signal computing unit 5.

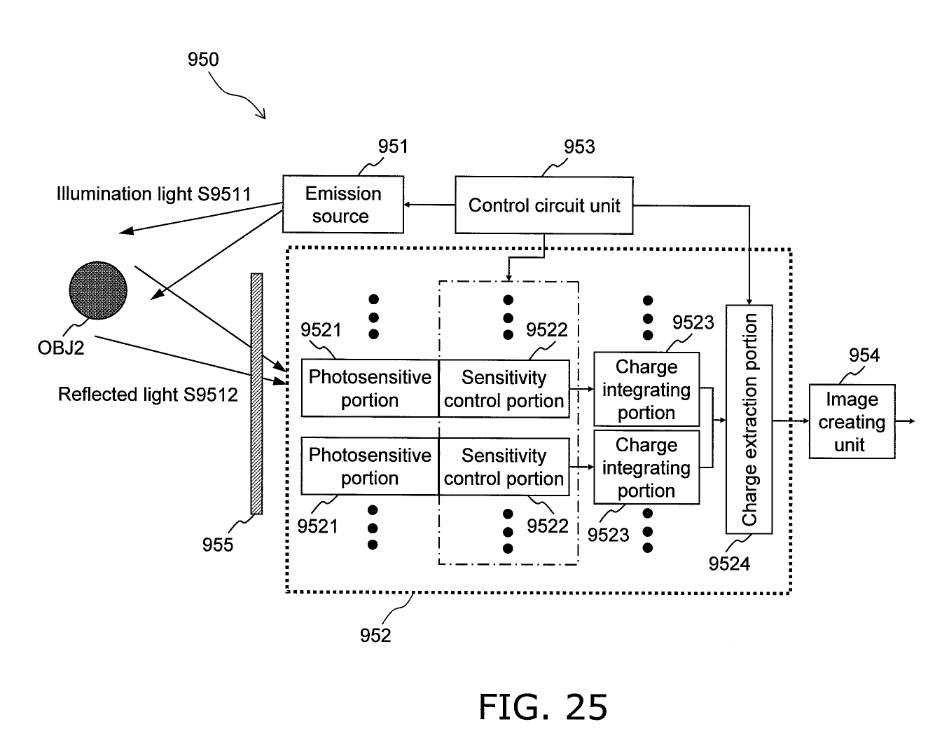

As in Conventional example 2, in the distance estimating device 100, sampling of the charge signal Di is performed at four points (four points of point A0, point A1, point A2 and point A3) for one modulation cycle as shown in FIG. 25, and the phase difference amount ψ is derived by Equation 4. In the distance estimating device 100, the derived phase difference amount ψ (the phase amount obtained based on four points from A0 through A3) is applied to Equation 3 to obtain the distance information value Li for the pixel i.

FIG. 3A is a schematic view of the optimum emission frequency determining process (the process of the “emission frequency selection mode”); and FIG. 3B is a schematic view of a process after the optimum emission frequency is determined (the process of the “distance image obtaining mode”). FIGS. 3A and 3B illustrate the case where the plurality of emission sources 9A through 9N are light sources which emit infrared light.

As described above, in the distance estimating device 100, reflected light from the object when no light being emitted from the light sources is received, and the light source which irradiates light (electromagnetic waves) insusceptible to environment light is selected based on the frequency analysis of the reflected light. Then, the selected light sources emits light, and the light receiving signal is obtained from the light reflected from the object (the charge signal Di acquired by the light receiving element unit 2 and the charge integrating unit 3), and the distance image is acquired from the light receiving signal. In sum, the distance estimating device 100 can acquire a distance image based on the light receiving signal which is insusceptible to the environment light component (the charge signal Di acquired by the light receiving element unit 2 and the charge integrating unit 3).

In the distance estimating device 100, the environment light component (constant noise) is small in the light receiving signal (the charge signal Di acquired by the light receiving element unit 2 and the charge integrating unit 3). Thus, S/N ratio of the light receiving signal (charge signal Di) is good.

For acquiring the distance image of a high resolution and high frame rate, charge detection period (charge accumulation time) for each pixel has to be made short at the light receiving element unit 2 and the charge integrating unit 3 and reading out has to be performed rapidly. In the distance estimating device 100, since environment light component (constant noise) is small in the light receiving signal (the charge signal Di acquired by the light receiving element unit 2 and the charge integrating unit 3), the charge detection period (charge accumulation time) for each pixel can be made short at the light receiving element unit 2 and the charge integrating unit 3, and the charge signal Di with good S/N ratio can be acquired even when reading out is performed rapidly. In this way, a good distance image of a high resolution and high frame rate can be acquired.

Furthermore, in the distance estimating device 100, since environment light component (constant noise) is small in the light receiving signal (the charge signal Di acquired by the light receiving element unit 2 and the charge integrating unit 3), there is an allowance until saturation occurs, and the charge detection period (charge accumulation time) at the light receiving element unit 2 and the charge integrating unit 3 can be made long. Therefore, in the distance estimating device 100, the charge detection period (charge accumulation time) at the light receiving element unit 2 and the charge integrating unit 3 may be increased so that the charge signal Di with further good S/N ratio can be acquired. Since the distance image is acquired based on such a charge signal Di, increasing the precision of the distance image can be readily achieved.

### Second Embodiment

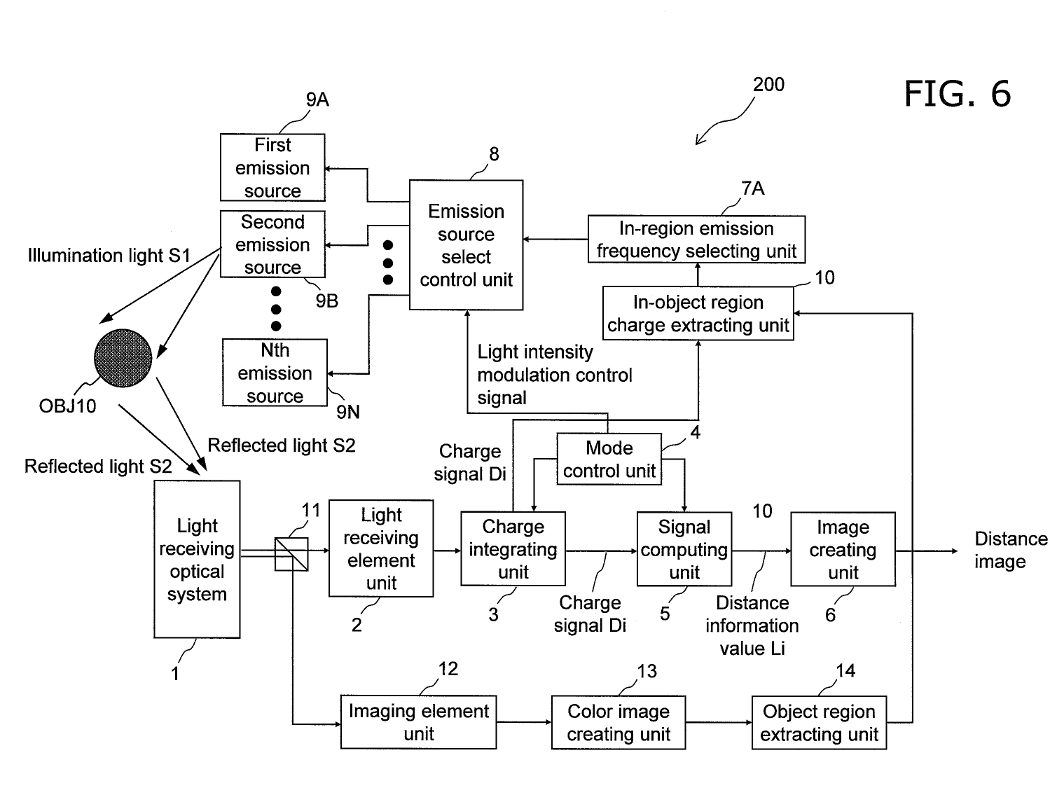

With reference to FIGS. 6 through 11, a distance estimating device and a distance estimating method for performing a distance estimating process by a light source having an insusceptible emission frequency based on an environment light distribution within an object region extracted from a color image are described as the second embodiment of the present invention.

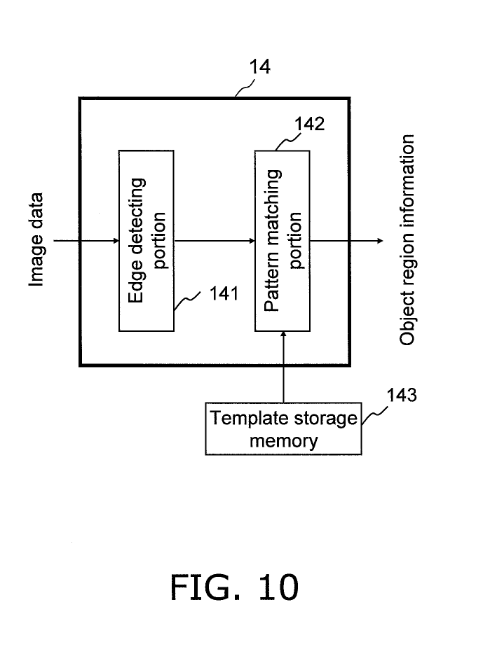

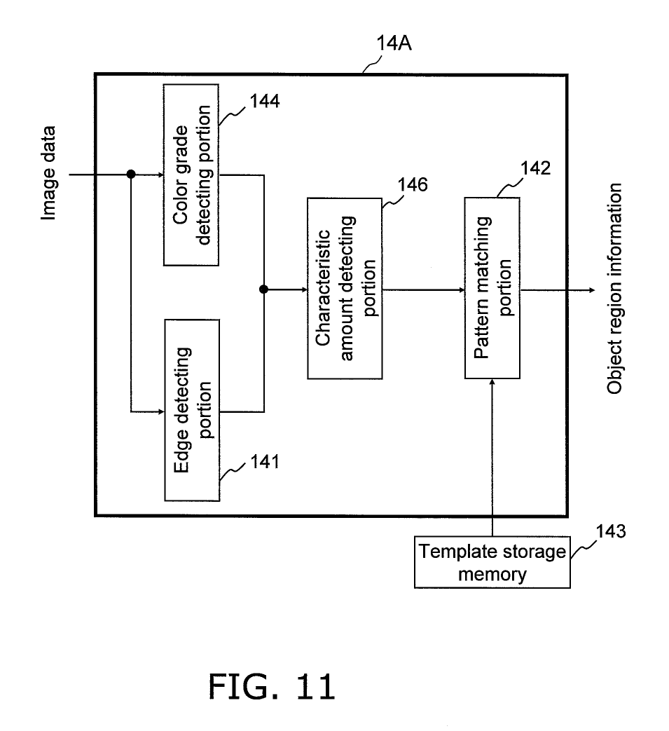

FIG. 6 is a schematic diagram showing a structure of a distance estimating device 200 according to the second embodiment of the present invention. FIGS. 10 and 11 are schematic diagrams showing object region extracting units 14 and 14A of the distance estimating device 200 according to the second embodiment of the present invention.

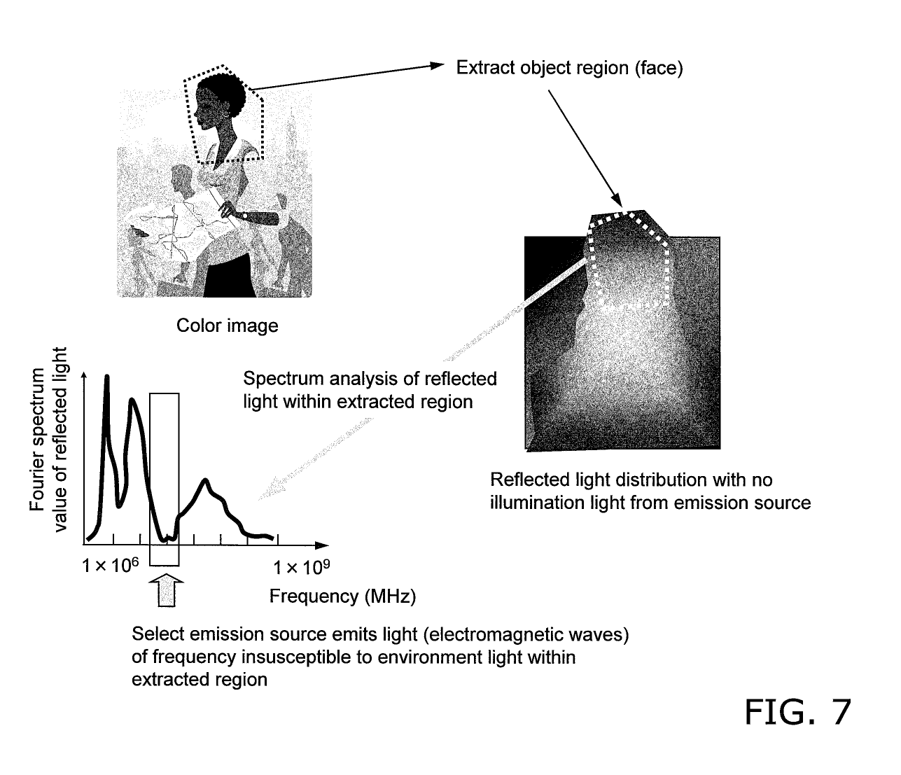

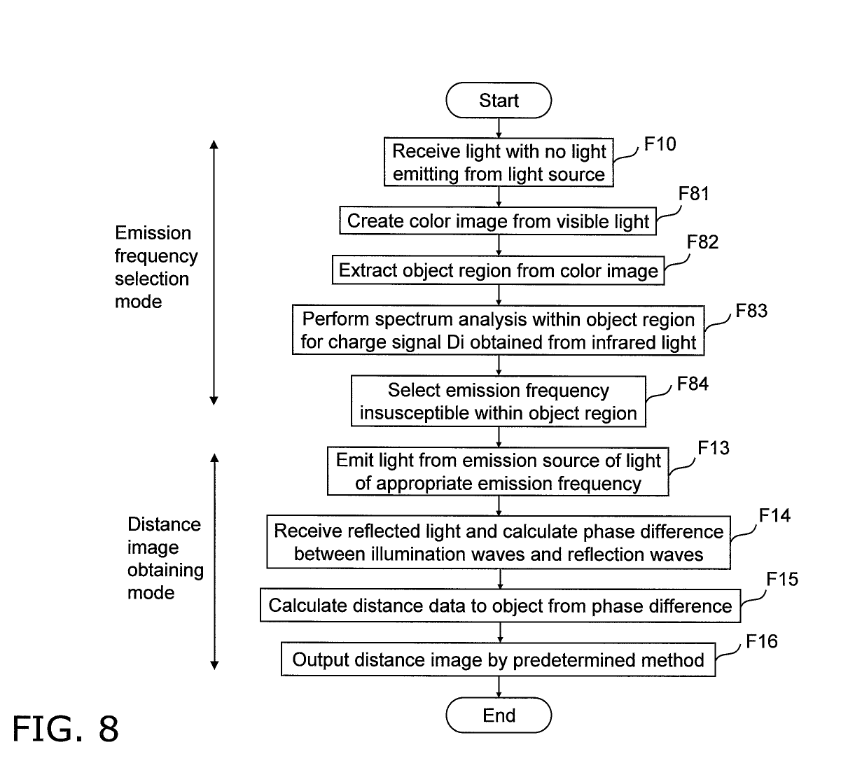

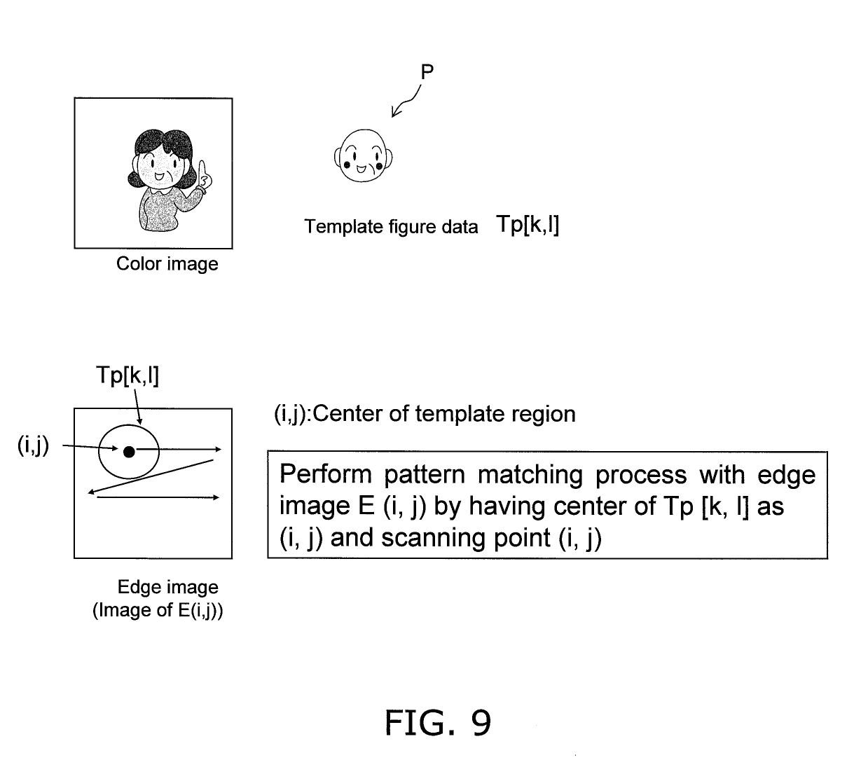

FIG. 7 is a schematic diagram showing an outline of a method for selecting an emission frequency of a light source in the distance estimating method according to the second embodiment. FIG. 8 is a flow diagram of the distance estimating method according to the second embodiment. FIG. 9 shows an example of pattern matching in extracting an object region. The components similar to those in the first embodiment are denoted by the same reference numerals and will not be further described.

<2.1: Structure of the Distance Estimating Device>

As shown in FIG. 6, the distance estimating device 200 according to the present embodiment is the distance estimating device 100 according to the first embodiment with the emission light frequency selecting unit 7 being replaced by an in-region emission light frequency selecting unit 7A, and further including a color separation prism 11, an imaging element unit 12, a color image creating unit 13, an object region extracting unit 14, and an in-region charge extracting unit 10. Other than these components, the distance estimating device 200 is similar to the distance estimating device 100, and thus, detailed descriptions will be omitted.

The color separation prism 11 is an optical prism which separates optical paths depending upon frequencies of light (electromagnetic waves). In the distance estimating device 200, the reflected light S2 condensed at the light receiving optical system is separated into an infrared light component for distance estimation and a visible light component for color images. The light (electromagnetic waves) of the infrared light component for distance estimation separated at the color separation prism 11 impinges upon the light receiving element unit 2. The light (electromagnetic waves) of the visible light component for color images separated at the color separation prism 11 impinges upon the imaging element unit 12.

The imaging element unit 12 includes an imaging element consisting of a plurality of pixels, and each of the pixels includes photoelectric conversion elements such as photodiodes or the like. The imaging element unit 12 acquires and accumulates charges corresponding to the received light amount which is photo-electrically converted at each pixel. The imaging element unit 12 outputs the integrated charges to the color image creating unit 13. The imaging element unit 12 may be, for example, a CCD-type image sensor, CMOS-type image sensor, or the like.

The color image creating unit 13 receives charges which are output from the imaging element unit 12 in correspondence with the pixels, and creates color image signals from the charges. The color image creating unit 13 outputs the created color image signals to the object region extracting unit 14.

As shown in FIG. 10, the object region extracting unit 14 includes an edge detecting portion 141 and a pattern matching portion 142.

The edge detecting portion 141 receives the color image signals (image data) from the color image creating unit 13 as an input, and extracts edge pixels from the color image signals to acquire edge information. The edge detecting portion 141 outputs the acquired edge information to the pattern matching portion 142.

The pattern matching portion 142 receives the edge information from the edge detecting portion 141 as an input, and treats the edge information with a pattern matching process to extract the object region information. The pattern matching portion 142 outputs the extracted object region information to the in-region charge extracting unit 10.

The in-region charge extracting unit 10 receives the charge signal Di output from the charge integrating unit 3 and the object region information output from the object region extracting unit 14 as input and extracts only the charge signal Di within the image region indicated by the object region information to output to the in-region emission light frequency selecting unit 7A.

<2.2: Structure of the Distance Estimating Device>

The operations of the distance estimating device 200 having the above-described structure is described below.

In the distance estimating device 200, the plurality of the emission sources 9A through 9N are emission sources which emit light of infrared region (infrared light). It is needless to say that electromagnetic waves outside the infrared region may also be used.

The operations of the distance estimating device 200 at the “emission frequency selection mode” is described.

In the distance estimating device 200, none of the plurality of the emission sources 9A through 9N emit light. In such a state, light from the object OBJ10 impinges upon the light receiving optical system 1.

The light impinges upon the light receiving optical system 1 is separated into the light of the infrared light component for the distance estimation and the light of the visible light component for the color images by the color separation prism 11.

The light of the infrared light component for the distance estimation is subjected to photoelectric conversion and charge integration (accumulation) by the light receiving element unit 2 and the charge integrating unit 3, and is output to the in-region charge extracting unit 10 as the charge signal Di which corresponds to the pixel i of the imaging element of the light receiving element unit. The charge accumulation time and output timing at the charge integrating unit 3 is controlled by the mode control unit 4.

On the other hand, the light of visible light component separated at the color separation prism 11 is received and integrated by the imaging element unit 12 and is converted into the color image signal (image data) at the color image creating unit 13. Then, the color image signal acquired at the color image creating unit 13 is output to the object region extracting unit 14.

The object region extracting unit 14 has a structure as shown in FIG. 10, for example.

As shown in FIG. 10, a template storage memory 143 may be formed of an external memory outside the object region extracting unit 14. However, the template storage memory 143 may be included in the object region extracting unit 14.

In the edge detecting portion 141, the edge information is acquired from the input color image signal (image data). The process at the edge detecting portion 141 is described below in detail.

In the edge detecting portion 141, differential vector vd(i, j) (xd(i, j), yd(i, j)) of the pixels (i, j) in the image is obtained by a two dimensional filter process (process of Equation 9) by the two dimensional filter having a size of 3×3 shown by Equation 8. The size stv(ij) of the differential vector vd(i, j) is obtained by:

stv(ij)=(xd(i,j)×xd(i,j)+yd(i,j)×yd(i,j)̂0.5.

In the edge detecting portion 141, stv(i, j) of the pixels (i, j) are compared as in Equation 10 by using a predetermined threshold value TH2 to extract edge pixels. Equation 10 is for digitalizing pixels in order to indicate whether pixels on the image formed by the color image signals are included in the edge or not. E(i, j)=1 denotes that the pixel (i, j) is the pixel included in the edge.

$$\begin{matrix}Equation 8 & \\ fx = [ \begin{matrix}{fx}_{00} & {fx}_{10} & {fx}_{20} \\ {fx}_{01} & {fx}_{11} & {fx}_{21} \\ {fx}_{02} & {fx}_{12} & {fx}_{22}\end{matrix} ] = [ \begin{matrix}- 1 & 0 & 1 \\ - 2 & 0 & 2 \\ - 1 & 0 & 1\end{matrix} ] , \\ fy = [ \begin{matrix}{fy}_{00} & {fy}_{10} & {fy}_{20} \\ {fy}_{01} & {fy}_{11} & {fy}_{21} \\ {fy}_{02} & {fy}_{12} & {fy}_{22}\end{matrix} ] = [ \begin{matrix}- 1 & - 2 & - 1 \\ 0 & 0 & 0 \\ 1 & 2 & 1\end{matrix} ] & ( 8 ) \\ Equation 9 & \\ xd ( i , j ) = {\sum }_{n = - 1}^{1} {\sum }_{m = - 1}^{1} {fx}_{n + 1 m + 1} \cdot k ( i - n , j - m ) \\ yd ( i , j ) = {\sum }_{n = - 1}^{1} {\sum }_{m = - 1}^{1} {fy}_{n + 1 m + 1} \cdot k ( i - n , j - m ) & ( 9 ) \\ Equation 10 & \\ E ( i , j ) = [ \begin{matrix}1 & if ( stv ( i , j ) \geq TH 2 ) \\ 0 & if ( stv ( i , j ) < TH 2 )\end{matrix} & ( 10 )\end{matrix}$$

The edge information E (i, j) obtained in this way by the edge detecting portion 141 (hereinafter, may also be denoted as “edge information Ei”, simply) is output to the pattern matching portion 142.

Next, at the pattern matching portion 142, the edge information Ei obtained by the edge detecting portion 141 is treated with a pattern matching process with figure data of the object region prepared previously in the template storage memory 143 to extract the object region. The details are now described.

The object regions through which the object region extraction is performed may be, for example, face region, person region (upper body, whole body), facial part regions such as eyes, nose, mouse, and the like.

When the object region is a face region, the template storage memory 143 stores normal figure data for the face region (which may be plural, or figure data in multiple directions).

When the object region is a person region, the template storage memory 143 stores normal figure data for the person region (which may be plural, figure data in multiple directions, or an upper body or a whole body).

When the object region is a part region such as eyes, nose or mouse, the template storage memory 143 stores normal figure data for each of the part regions.

By performing the pattern matching process between the figure data Tp[k,1](p=1, . . . , Pnum)(k=0, 1, . . . Wp−1)(1=0, 1, . . . , Hp−1) stored in the template storage memory 143 and the edge information E (i, j) of the pixels (i, j), the corresponding region (object region information) is extracted by the pattern matching portion 142. Herein, Pnum is the number of the templates, and Wp, Hp are the number of horizontal pixels and the number of vertical pixels of rectangular templates.

There are many methods for the pattern matching process performed by the pattern matching portion 142. An example of a simple method is the method shown in FIG. 9. Hereinafter, this method is described. FIG. 9 is a schematic view illustrating an example of the pattern matching method.

The pattern matching portion 142 sets rectangular region candidate SR[i, j, Wp, Hp] which has a horizontal width Wp and a vertical width Hp, with the center being the pixel (i, j).

Then, the pattern matching portion 142 obtains evaluation function R(i, j, p) such as Equation 11 based on the edge information E(i, j) in the rectangular region candidate SR[i, j, Wp, Hp] and the figure data Tp[k, 1]((k=0, 1, . . . Wp−1)(1=0, 1, . . . , Hp−1)) stored in the template storage memory 143.

Next, the pattern matching portion 142 obtains MR with which the evaluation function R(i, j, p) becomes the maximum for the template p and the pixel (i, j) as shown in Equation 12. In Equation 12, MAX means that obtaining the maximum value R(i, j, p) for the pixel (i, j) and the template p. When the maximum value MR is equal to or larger than the predetermined threshold value THMR, the rectangular region candidate SR[i, j, Wp, Hp] corresponding to the maximum value MR is extracted as the object region information BestSR[i, j, W, H] which has been seek for.

By comparing with the predetermined threshold value THMR, matching to noises can be suppressed. When the maximum value MR is smaller than the threshold value THMR, it is determined that there is no object region, and information of the input image [width/2, height/2, width, height] is output as the object region information BestSR[i, j, W, H]. Herein, width refers to the number of horizontal pixels of the input image and the height refers to the number of vertical pixels of the input image.

$$\begin{matrix}Equation 11 & \\ R ( i , j , p ) = {\sum }_{k = 0}^{Wp - 1} {\sum }_{l = 0}^{Hp - 1} Tp [ k , l ] \cdot E ( i - Wp / 2 + k , j - Hp / 2 + l ) & ( 11 ) \\ Equation 12 & \\ Best SR [ i , j , W , H ] = \{ SR [ i , j , Wp , Hp ] \vert Mr = {max}_{( i , j ) , p} \{ R ( i , j , p ) \} , MR \geq THMR \} & ( 12 )\end{matrix}$$

The object region information BestSR[i, j, W, H] obtained by the pattern matching portion 142 as described above is output to the in-region charge extracting unit 10.

In the in-region charge extracting unit 10, only the charge signal Di of the pixel i included in the object region information BestSR[i, j, W, H] is extracted and output to the in-region emission light frequency selecting unit 7A.

In the in-region emission light frequency selecting unit 7A, the charge signal Di output from the in-region charge extracting unit 10 is treated with a process similar to that by the emission frequency selection 7 in the first embodiment.

The following processes are similar to those in the first embodiment, and thus, the description is omitted.

The operations of the distance estimating device 200 at the distance image obtaining mode are similar to those in the first embodiment, and thus, will not be described.

With reference to FIG. 7, the summary of the operations of the distance estimating device 200 is described.

As schematically shown in FIG. 7, the in-region emission light frequency selecting unit 7A of the distance estimating device 200 selects the optimum emission frequency Fbest based on the object region information obtained at the object region extracting unit 14 from the color image (image formed of the color image signals) created at the color image creating unit 13.

More specifically, in the distance estimating device 200, the object region which is required is first extracted from the color image created from the light of visible light component. Then, the charge signal Di of the infrared light reflected light (with no light emitting from any of the plurality of emission sources 9A through 9N) included in the object region is subjected to the spectrum analysis. The, the emission frequency with small influence by the environment light within only the object region is obtained.

In the distance estimating device 200, the light source of the emission frequency determined by the in-region emission light frequency selecting unit is used to perform the distance measuring process and obtain the distance image.

In the distance estimating device 200 and the distance estimating method according to the present embodiment, a predetermined object region is extracted from the color image obtained from the light of the visible light components. The reflected light within the region corresponding to the object region extracted from the color image is subjected to frequency analysis (spectrum analysis) in the distance image data obtained by receiving the light reflected from the object with no light emitted from the light sources. Then, the distance estimating device 200 selects the light source which irradiates light having the emission frequency which is insusceptible to the environment light based on the result of the spectrum analysis of the object region, and the distance estimating process is processed with the illumination light to obtain the distance image.

In such a way, the distance estimating device 200 can perform the distance estimating process with the illumination light which has less influence on the distance precision of the focused object region. Thus, the distance image with further improved precision can be obtained for the focused object region.

In the process of Equation 11 above, an average value of the edge information E(i, j) and an average value of the figure data Tp [k, 1] can be obtained and the process of the distance estimating device 200 may be performed based on values obtained by subtracting the average values from the each of the values (subtraction values). Alternatively, the minimum value of the edge information E(i, j) and the minimum value of the figure data Tp [k, 1] may be obtained and the values obtained by subtracting the minimum values from the respective values (subtracted values). Further, average values, the maximum values, or upper limit set values within the possible range in the candidate region SR[i, j, W, H] of the subtracted values in the edge information or figure data may be obtained, and the values may be normalized by dividing with those values to perform the process in the distance estimating device 200. By employing such methods, influence of large variable components when the pattern matching process is performed can be suppressed to a certain degree.

In the distance estimating device 200, the object region extracting unit 14 may be replaced with an object region extracting unit 14A shown in FIG. 11.

The object region extracting unit 14A is incorporated with a color grade detecting portion 144 for detecting grade of colors of the pixels with respect to the edge information E(i, j) of the pixels (i, j) obtained at the edge detecting portion 141.

The color grade detecting portion 144 further impose restrictions with color information in the object region in order to improve the precision and the speed at the pattern matching portion 142.

When the object region is a face region, the color grade detecting portion 144 calculates skin color grade amount C (i, j) for the pixels (i, j) of the color image. Then, a characteristic amount extracting portion 146 obtains characteristic amount SE (i, j), which is a combination of the color degree amount C (i, j) and the edge information E (i, j) for each of the pixels (i, j). There are various methods for obtaining, but a simple method is as shown by Equation 13.

Equation 13

SE(i,j)=w_{c}×C(i,j)+wₑ×E(i,j)w_{c}+wₑ=1 (13)

The characteristic amount SE (i, j) may also be obtained by using non-linear function conversion with the color degree amount C (i, j) and the edge information E (i, j) being two variants as in Equation 14.

Equation 14

r(i,j)=\sqrt{C(i,j)²+E(i,j)²}SE(i,j)=1.0/(1.0+exp(−Keisu×(r(i,j)−0.5))) (14)

In the object region extracting unit 14A, thus-obtained characteristic amount SE (i, j) is used and the pattern matching process is performed as in the object region extracting unit 14 to perform object region extraction.

### Third Embodiment

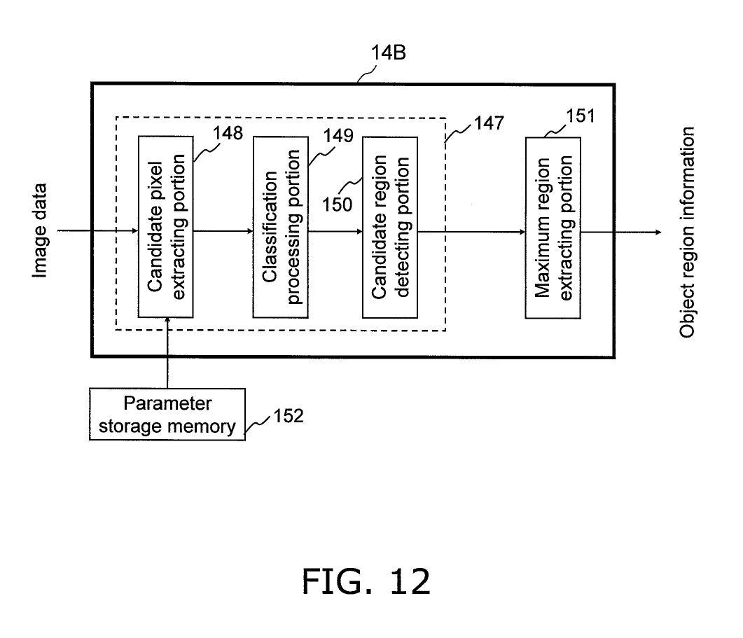

With reference to FIGS. 12 through 15, a distance estimating device which uses a light source having an emission frequency with has less influence based on environment light distribution in an object region extracted from a color image and a distance estimating method as the third embodiment of the present invention.

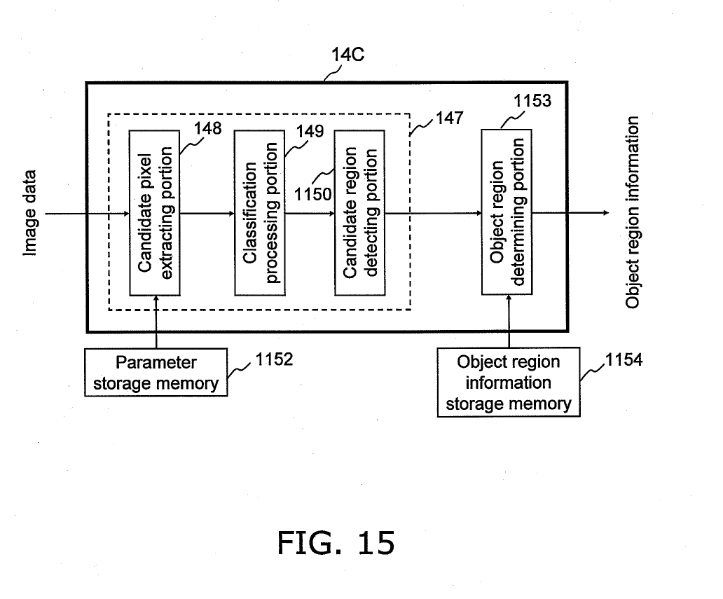

FIGS. 12 and 15 shows object region extracting units 14B and 14C in the distance estimating device according to the third embodiment of the present invention.

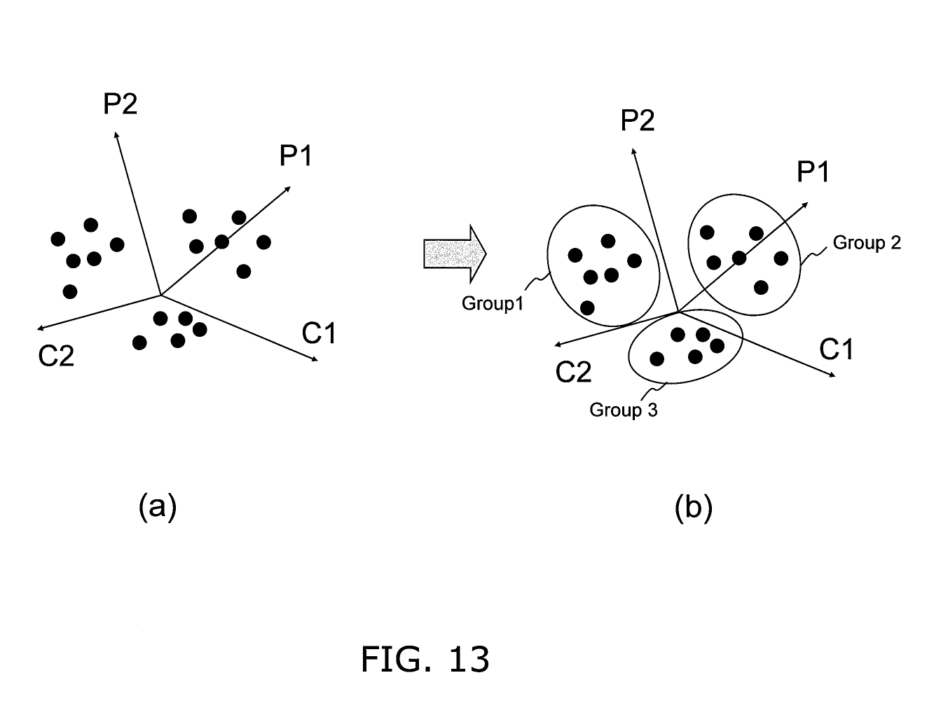

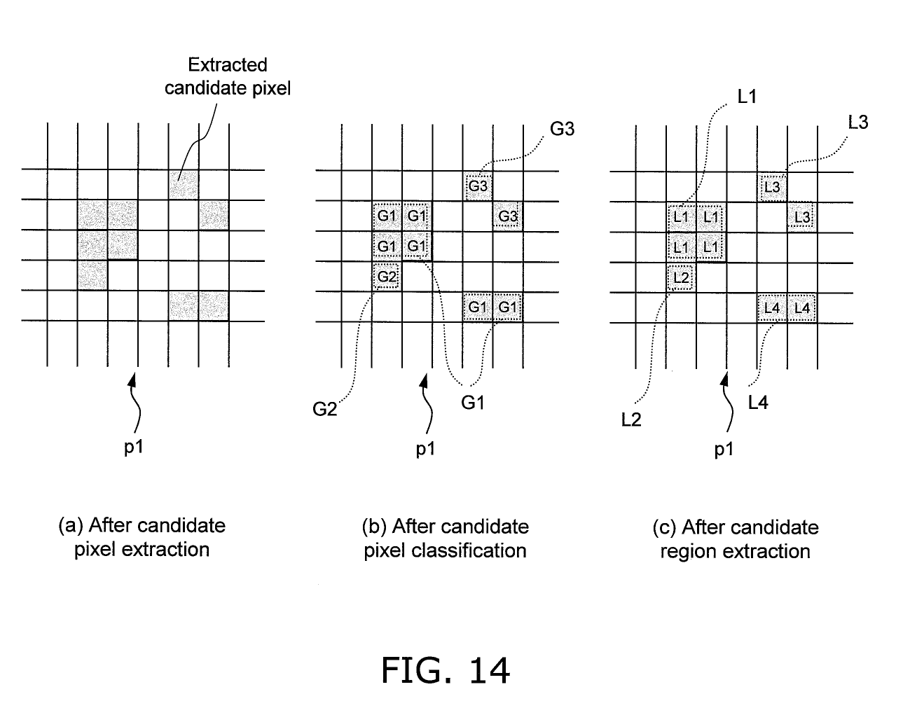

FIG. 13 is a diagram showing a summary of a classifying method in the object region extracting units 14B and 14C in the distance estimating device according to the third embodiment. FIG. 14 is a schematic view showing how candidate pixel is extracted, classified and candidate region is detected in the distance estimating device according to the third embodiment. Components similar to those in the above embodiments are denoted by the same reference numerals, and the descriptions thereof are omitted.

The distance estimating device according to the present embodiment is different from the distance estimating device 200 of the second embodiment in that the object region extracting unit 14 or 14A is replaced with the object region extracting units 14B or 14C. Other components are similar as those in the distance estimating device 200 of the second embodiment.

With reference to FIGS. 12 through 14, the distance estimating device and the distance estimating method of the third embodiment of the present invention are described. The processes other than that in the object region extracting unit is similar to those in the second embodiment, and thus, will not be further described.

As in the second embodiment, the in-region emission light frequency selecting unit 7A selects the optimum emission frequency Fbest based on the object region information obtained by the object region extracting unit 14B from the color image created at the color image creating unit 13 as schematically shown in FIG. 7.

As shown in FIG. 12, the object region extracting unit 14B comprises: a region detecting portion 147, which is formed of a candidate pixel extracting portion 148, a classification processing portion 149, and a candidate region detecting portion 150; and a maximum region extraction portion 151. In FIG. 12, a parameter storage memory 152 is an external memory. However, the object region extracting unit 14B may include the parameter storage memory 152.

First, as shown in FIG. 13A, the candidate pixel extracting portion 148 of the object region extracting unit 14B treats the pixels in the color image with a determining process whether they are candidate pixels or not. The determining process may be performed by, for example, detecting the color degree of the object region and determining the pixel having the color degree larger than a predetermined threshold value TH3 to be the candidate pixel as in the color grade detecting portion 144 in the second embodiment. In such a case, the color degree may be defined such that, differences between target color information of the object region (for example, values Cr0, Cb0 of Cb and Cr in YcbCr color space) and the values of Cb, Cr of each of the pixels are obtained, and the color degree Ci becomes small as the difference becomes large. In this case, the target color information of the object region (for example, values Cr0, Cb0 of Cb and Cr in YcbCr color space) do not have to be one, but may be plural. The color degree of the pixel i in such a case is an average of the color degrees obtained from the differences between the pixel i and the target color information. Alternatively, the possible region of the color information of the object region may be set, and the color degree of the pixel i may be determined from the differences between the central value of the region and the values of Cb, Cr of the pixel i.

Next, the classification processing portion 149 of the target region extracting unit 14B treats the candidate pixel Pes (s=1, . . . , MMM) selected by the above-described determining process at the candidate pixel extracting portion 148 with a classifying process as shown in FIG. 13.

The classifying process is performed by determining a vector VEs having color information C1s, C2s representing Pes and pixel positions P1s, P2s as components, and applying a vector quantizing method to a vector set thereof. The vector quantizing method is a method of classifying a plurality of vectors Vt(t=1, . . . , Total) into close mass (cluster, groups) based on predetermined evaluation values. Examples of C1, C2 may be the color information Cb, Cr, and examples of P1, P2 may be pixel coordinates x, y. However, these examples are not limiting, and C1, C2 may also be S (chroma) and H (hue), or may be chromaticity a*, chromaticity b* in a La*b* color space. In other words, by using known color components of color spaces used as color information in the color image, classifying process with a sense closer to that of a user becomes possible.

FIG. 14 is a schematic diagram showing a classifying process at the classification processing portion 149 of the object region extracting unit 14B.

G1, G2 and G3 in FIG. 4B indicate clusters. The clusters of G1 through G3 are classified by the classification processing portion 149. Further, the candidate region detecting portion 150 regionalize the clusters G1, G2, and G3 based on the positions of the clusters. In this example, regionalizing is performed based on whether eight candidate pixels surrounding the candidate pixel after the classification of the clusters are coupled or not. For example, in FIG. 14B, two separate bulks are denoted by the same cluster number, G1. By the coupling determining process at the candidate region detecting portion 150, as shown in FIG. 14C, different region numbers are attached to L1 and L4. There are various methods in the coupling process, and the process may be performed with the candidate region detecting portion 150 by a method in which a distance defined by a difference between the pixel value of the known object pixel and a pixel values of the surrounding pixels in the image processing, and it is determined that the object pixel and the surrounding pixels have similar values (are coupled) if the distance value is smaller than the predetermined threshold value TH4.

In such a way, the candidate region (a plurality of cluster regions) are detected by the candidate region detecting portion 150. The candidate region (a plurality of cluster regions) detected by the candidate region detecting portion 150 is checked by the maximum region extraction portion 151 so as to determine the number of pixels of the cluster regions, and the candidate region having the maximum number of pixels is extracted as the object region. The information indicating the extracted object region is output from the maximum region extraction portion 151 to the in-object region charge extracting unit 10 as the object region information.

In this way, the distance estimating device of the present embodiment can automatically extract a region to be the object in accordance with the color distribution in the image. Thus, dependence on the template figure data which has been prepared previously as in the second embodiment can be suppressed, and also, influence on the image value variance during creation of color image (influence due to a variance in the environment light and/or a variance in charge conversion at the imaging element such as CCDs) may be mitigated.

The distance estimating device and the distance estimating method of the third embodiment group the pixels based on brightness, color information and the like when the object region is extracted in the distance estimating device and the distance estimating method of the second embodiment to divide regions, and the region which attracts high attention in the image can be automatically extracted. In the distance estimating method of the distance estimating device of the third embodiment, the light source which illuminates light having an emission frequency which is insusceptible to the environment light is selected based on the result of spectrum analysis of the automatically extracted region. The distance estimating process is performed with the illumination light and the distance image is obtained. Therefore, the distance estimating device and the distance estimating method of the third embodiment can obtain the distance image with a high precision in the region which draws high attention in the image.

Instead of the object region extracting unit 14B, an object region extracting unit 14C having a structure as shown in FIG. 15 may be used.

As shown in FIG. 15, the object region extracting unit 14C is the object region extracting unit 14 with the maximum region extraction portion 151 being replaced with an object region determining portion 153 and is further structured such that data stored in an object region information storage memory 154 can be used.

The object region extracting unit 14C calculates an evaluation value of the cluster from a center of gravity of the cluster, average color information, circularity of the cluster, the number of the pixels of the cluster for each of the cluster regions after the candidate region detection process is finished (the data which is reference of the evaluation values is stored in the object region information storage memory 154). The object region may be determined by extracting a plurality of cluster regions having the evaluation values higher than a predetermined threshold value TH5. Alternatively, one cluster region having the highest evaluation value is selected and extracted to be determined as the object region. With such a process by the object region extracting unit 14C, the object region can be determined further appropriately. Thus, the distance estimating process at the distance estimating device can be further precise.

### Fourth Embodiment

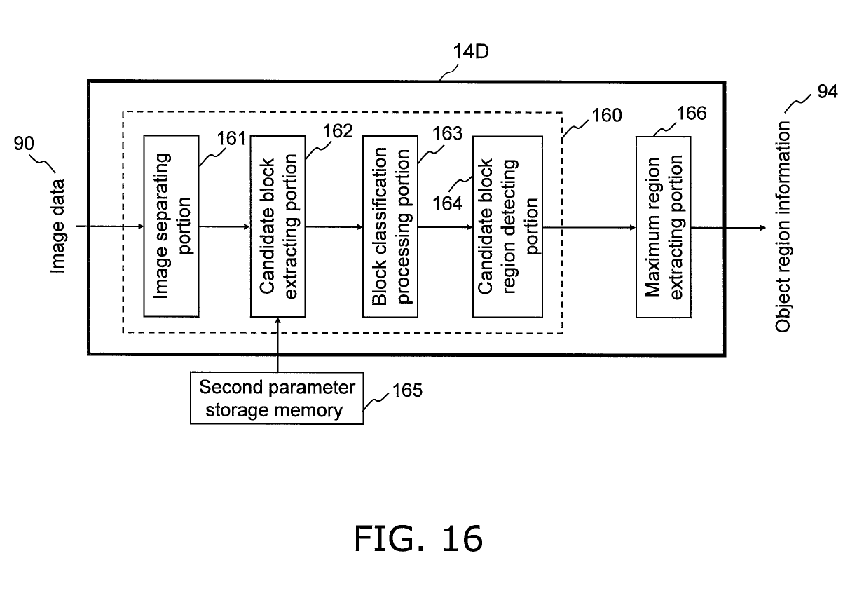

With reference to FIGS. 16 through 19, a distance estimating device and a distance estimating method using a light source having a insusceptible emission frequency based on a environment light distribution in an object region extracted from a color image (spectrum distribution of the environment light) as the fourth embodiment of the present invention.

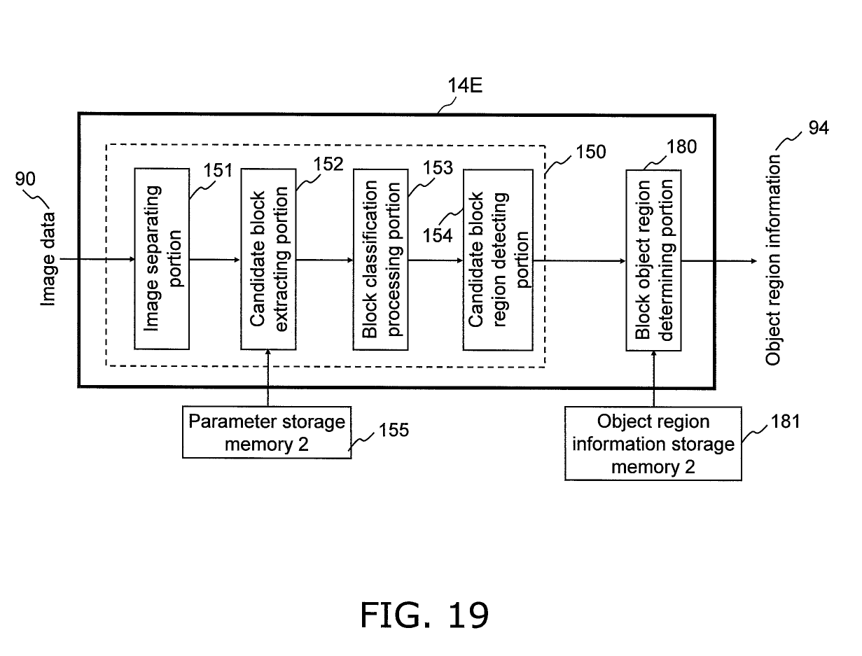

FIGS. 16 and 19 show object region extracting unit 14D and 14E in the distance estimating device according to the fourth embodiment of the present invention.

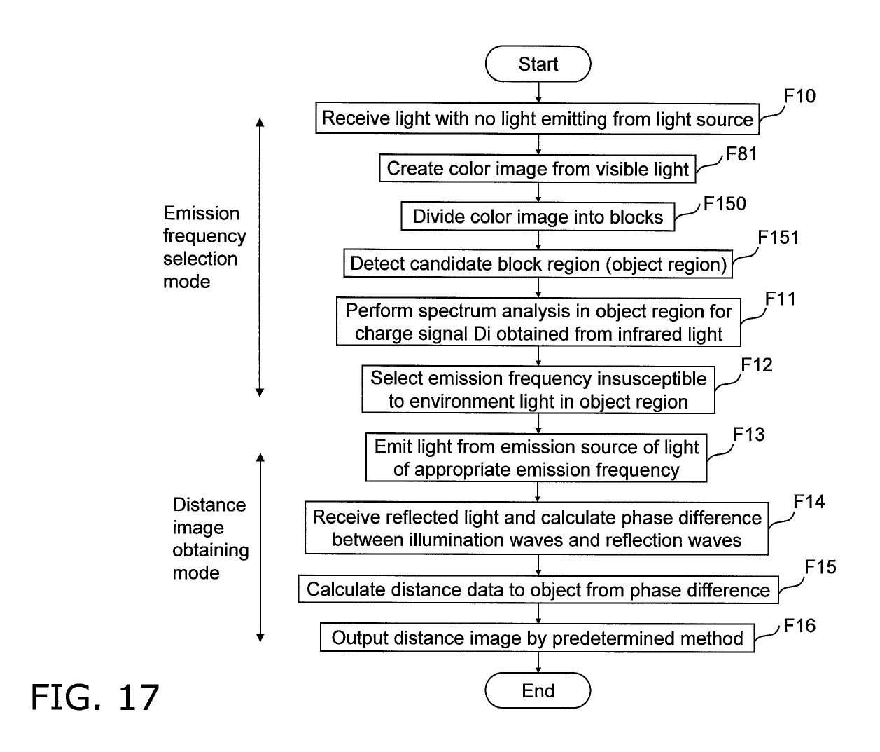

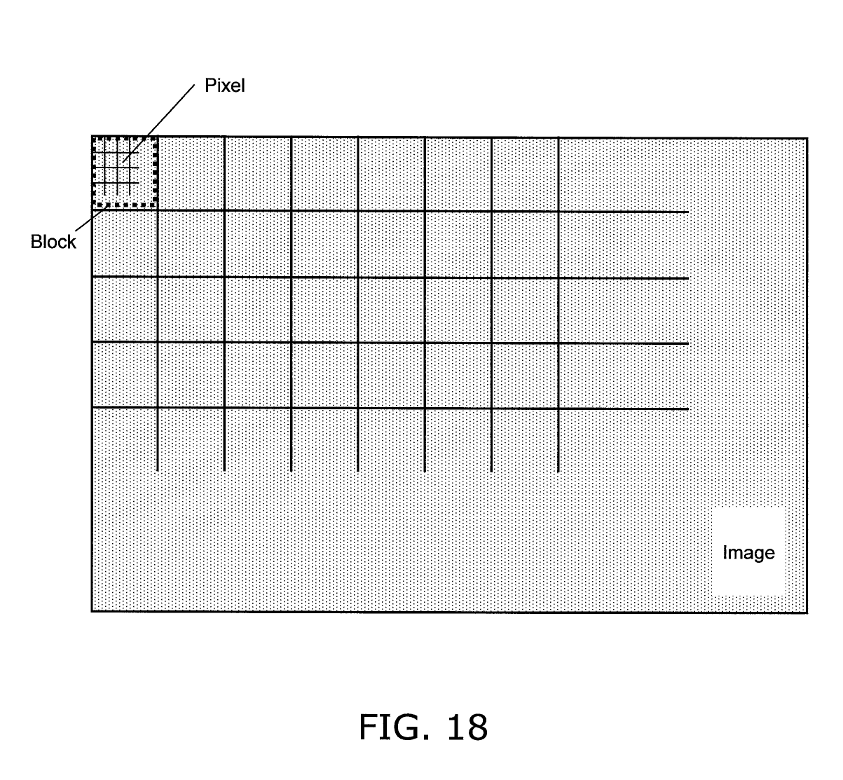

FIG. 18 is a diagram illustrating an image separating process at an image separating portion in the object region extracting unit in the distance estimating device according to the fourth embodiment of the present invention. FIG. 17 is a flow diagram showing a process of the distance estimating method according to the fourth embodiment of the present invention. Similar component as in the above embodiments are denoted by the same reference numerals, and will not be further described.

The distance estimating device according to the present embodiment is different from the distance estimating device 200 of the second embodiment in that the object region extracting unit 14 or 14A is replaced with the object region extracting unit 14D or 14E. Other components are similar to those in the distance estimating device 200 of the second embodiment.

As shown in FIG. 16, the object region extracting unit 14D is formed of a block region detecting portion 160, a maximum region extraction portion 166, a second parameter storage memory 165, which is an external memory. The block region detecting portion 160 is formed of an image separating portion 161, a candidate block extraction portion 162, a block classification processing portion 163, and a candidate block region detecting portion 164.

Hereinafter, the distance estimating device and the distance estimating method according to the forth embodiment of the present invention will be described. In the distance estimating device of the present embodiment, processes other than the object region extraction process are similar to those in the second embodiment, and thus, the detailed descriptions are omitted.

The characteristics of the present embodiment is that the target region extracting unit as in the third embodiment is performed not by the pixel unit, but, the color image is segmented into block units including a predetermined number of pixels as shown in FIG. 18, and the process similar to the object region extraction process of the third embodiment is performed by the block unit. The distance estimating device of the present embodiment which perform the process in this way can perform the processes of candidate pixel detection, candidate pixel classification, the candidate region detection by the pixel unit (see FIG. 14) in the block unit, and thus, the amount of processes can be reduced.

In the distance estimating device of the present embodiment, the object region extracting unit 14D shown in FIG. 16 may be replaced with an object region extracting unit 14E shown in FIG. 19. The object region extracting unit 14E of FIG. 19 corresponds to a block unit process version of the object region extracting unit 14C shown in FIG. 15 in the third embodiment, which is different on the point that the processing unit is a block unit.

### Fifth Embodiment

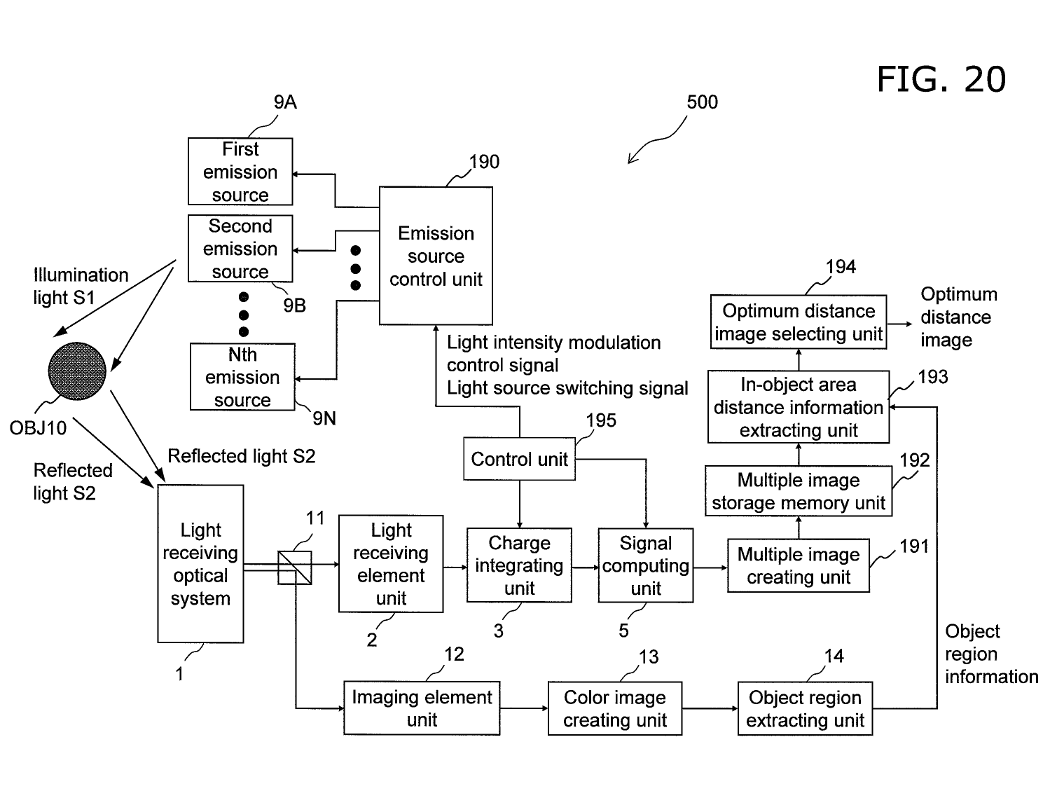

With reference to FIGS. 20 through 22, a distance estimating device and a distance estimating method according to the fifth embodiment of the present invention will be described.

FIG. 20 is a schematic diagram of a distance estimating device 500 according to the fifth embodiment of the present invention.

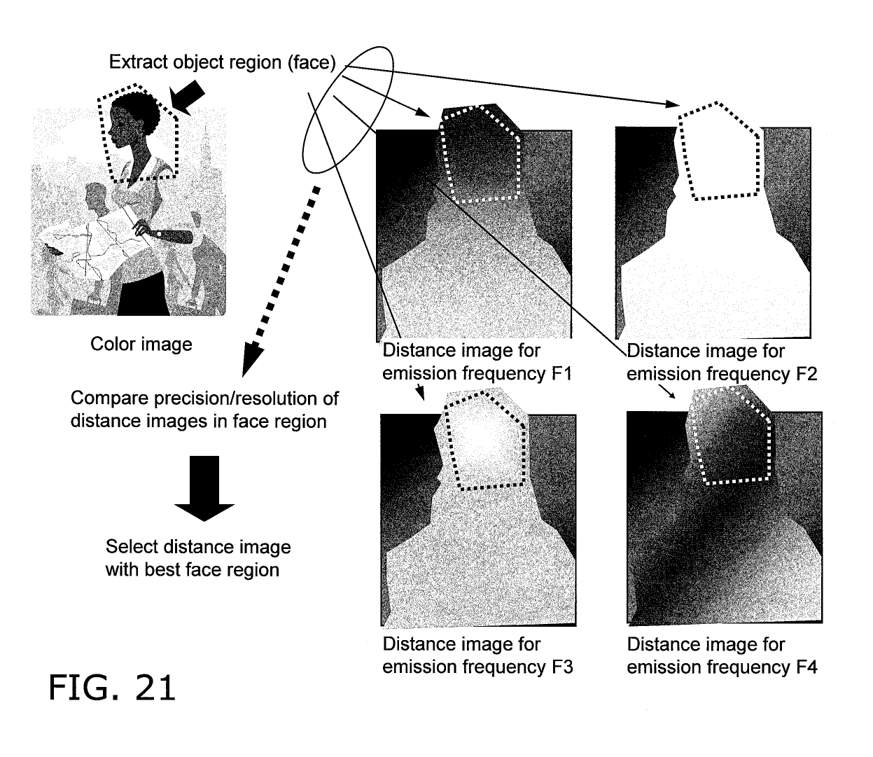

FIG. 21 is a schematic diagram showing a summary of the process (distance estimating method) in the distance estimating device 500 according to the fifth embodiment.

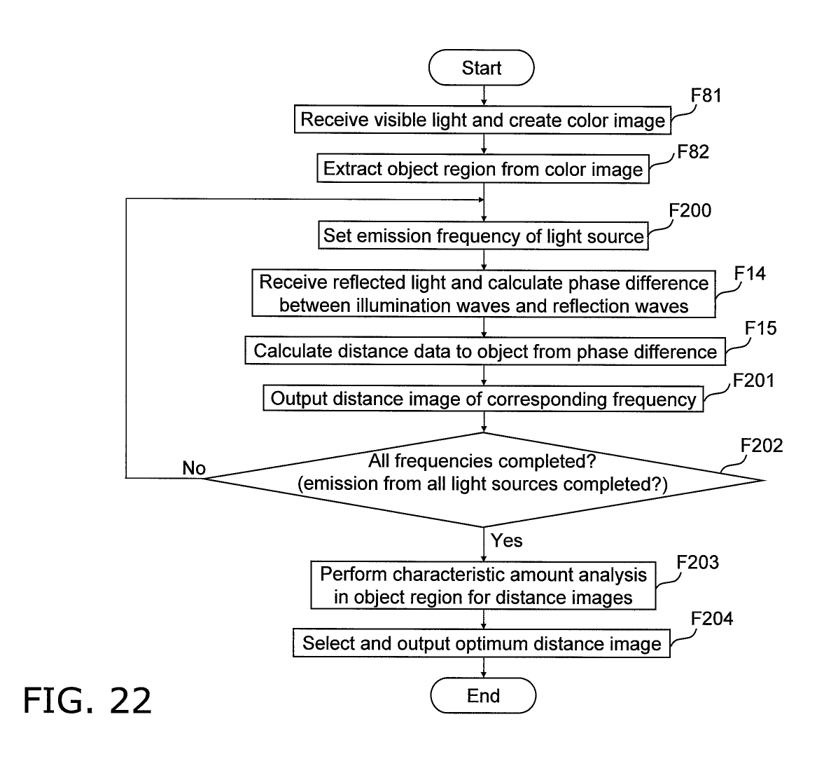

FIG. 22 is a process flow diagram of the distance estimating method according to the fifth embodiment. With reference to the flow diagram of FIG. 22, steps F81 and F82 may be placed anywhere as long as they are performed before step F203. Thus, the process is not limited to the flow diagram as shown in FIG. 22. Steps F81 and F82 may be immediately before step F203.

The components similar to those in the above embodiments are denoted by the same reference numerals, and will not be further described.

<5.1: Structure of the Distance Estimating Device>

As shown in FIG. 20, the distance estimating device 500 has a similar structure to the distance estimating device 200 of the second embodiment, except that the in-region emission light frequency selecting unit 7A and the in-object region charge extracting unit 10 are omitted, the mode control unit 4 is replaced with a control unit 195, the emission source select control unit 8 is replaced with a emission source control unit 190, and further, a multiple image creating unit 191, a multiple image memory unit 192, an in-object region distance information extracting unit 193 and an optimum distance image selecting unit 194 are added.

Other components are similar to those in the distance estimating device 200 of the second embodiment, and thus, descriptions are omitted.

The emission source control unit 190 are coupled to the plurality of emission sources 9A through 9N (first emission source 9A through Nth light source), and sequentially switches the light sources to emit light based on a light source switching signal from the control unit 195. The emission source control unit 190 also modulates light intensity of the light source which is emitting light based on a light intensity modulation control signal from the control unit 195 as the mode control unit 4 of the above-mentioned embodiment.

The control unit 195 outputs the light source switching signal and the light intensity modulation control signal to the emission source control unit 190, and controls light emission of the plurality of light sources through the emission source control unit 190. The control unit 195 also controls the charge integrating unit 3 and the signal computing unit 5 similarly to the control at the distance image obtaining mode of the mode control unit 4 in the above-mentioned embodiment.

The multiple image creating unit 191 receives distance information Li from the signal computing unit 5 and creates a distance image from the distance information Li. Then, the multiple image creating unit 191 outputs the obtained distance image to the multiple image memory unit 192 with the information indicating which light source among the first emission source 9A through the Nth emission source 9N is used to obtain the obtained distance image.

The multiple image memory unit 192 records and stores the distance image obtained from the multiple image creating unit 191 with the information of the light source when the distance image is obtained. Alternatively, the information of the light source when the distance image is obtained, which is to be recorded and stored in the multiple image memory unit 192, may be obtained from the control unit 195. The multiple image memory unit 192 output the recorded and stored distance image and the information of the light source when the distance image is obtained to the in-object region distance information extracting unit 193 in accordance with the request from the in-object region distance information extracting unit 193. The multiple image memory unit 192 is memory which can record and store distance images for at least the number of the light sources (N) and the information of the light sources.

The in-object region distance information extracting unit 193 receives the recorded and stored distance image and the information of the light source when the distance image is obtained from the multiple image memory unit 192 and the object region information output from the object region extracting unit 14 as input, and extracts the distance information in the object region from the distance image. The in-object region distance information extracting unit 193 outputs the extracted distance information in the object region to the optimum distance image selecting unit 194 with the information of the light source when the distance information is obtained.

The optimum distance image selecting unit 194 receives the distance information in the object region which is extracted by the in-object region distance information extracting unit 193 and the information of the light source when the distance information is obtained as input, determines the optimum distance image from the distance information in the object region, and outputs the determined optimum distance image. The optimum distance image selecting unit 194 evaluates the distance information in object regions of N number, which is the number of the light sources, based on a predetermined references, and determines the distance information which has the distance information in the object region is optimum. The optimum distance image selecting unit 194 determines the distance image which is obtained using the light source when the distance information which is determined to be optimum is obtained as the optimum distance image.

<5.2: Operations of the Distance Estimating Device>

With reference to FIGS. 20 through 22, the operations of the distance estimating device 500 having the structure as described above will be described. Operations similar to those of the distance estimating devices of the above-described embodiments will not be described.

The distance estimating device 500 of the present embodiment operates at one mode (without switching between modes) unlike the distance estimating device 200 of the second embodiment, which operates being switched between two modes (the emission frequency selecting mode and the distance image obtaining mode).

First, in the distance estimating device 500, a distance image with the first emission source 9A is obtained.

The control unit 195 outputs a light source switching control signal to have the first emission source 9A emit light to the emission source control unit 190. At the same time, the control unit 195 outputs a light intensity modulation control signal to the emission source control unit 190.

The emission source control unit 190 have the first light source 9A emit light based on the light source switching control signal from the control unit 195. Then, the emission source control unit 190 modulates light emitted from the first light source 9A (infrared light) based on the light intensity modulation control signal from the control unit 195.

The present embodiment will be described on the premises that light emitted from the first emission source 9A through the Nth emission source 9N is infrared light.

The light receiving optical system 1 receives light, which is emitted from the first emission source 9A, irradiates the imaging target space, and is reflected from the imaging target space (reflected light S2).

Based on the received light, the light receiving element unit 2, the charge integrating unit 3, and the signal computing unit 5 obtain the distance information Li as in the above-described embodiments.

The multiple image creating unit 191 creates the distance image from the distance information Li. The distance image created by the multiple image creating unit 191 is output to the multiple image storage memory unit 192 as the distance image obtained form the first emission source 9A. Herein, the distance image created from the first emission source 9A is represented as Img (9A) (similarly, the distance image created from the Nth light source 9N is represented as Img (9N)).

The multiple image memory unit 192 records and stores the distance image Img (9A) with the information indicating that the distance image Img (9A) is the distance image obtained by using the first emission source 9A.

Next, in the distance estimating device 500, a distance image with the second light source 9B is obtained.

The control unit 195 outputs a light source switching control signal to have the second light source 9B emit light to the emission source control unit 190. At the same time, the control unit 195 outputs a light intensity modulation control signal to the emission source control unit 190.

The emission source control unit 190 have the second light source 9B emit light based on the light source switching control signal from the control unit 195. Then, the emission source control unit 190 modulates light emitted from the second light source 9B (infrared light) based on the light intensity modulation control signal from the control unit 195.

The light receiving optical system 1 receives light, which is emitted from the first emission source 9A, irradiates the imaging target space, and is reflected from the imaging target space (reflected light S2).

Based on the received light, the light receiving element unit 2, the charge integrating unit 3, and the signal computing unit 5 obtain the distance information Li as in the above-described embodiments.

The multiple image creating unit 191 creates the distance image Img (9B) from the distance information Li. The distance image Img (9B) created by the multiple image creating unit 191 is output to the multiple image storage memory unit 192 as the distance image obtained form the second light source 9B.

The multiple image memory unit 192 records and stores the distance image Img (9B) with the information indicating that the distance image Img (9B) is the distance image obtained by using the second light source 9B.

Further, in the distance estimating device 500, distance images by the third light source 9C through the Nth light source 9N are obtained in the similar way as described above.

After all the distance images Img (9A) through Img (9N) are obtained and recorded and stored in the multiple image storage memory unit 192, the in-object region distance information extracting unit 193 extracts the distance information Li (9A) through Li (9N) from the distance images Img (9A) through Img (9N) within object region determined by the object region extracting unit 14. Herein, the distance information within object region obtained from the distance image Img (x) is denoted as Li(x).

The in-object region distance information extracting unit 193 outputs the extracted distance information Li (9A) through Li (9N) to the optimum distance image selecting unit 194.

The optimum distance image selecting unit 194 checks graduation characteristics of the distance images Img (9A) through Img (9N) within the object regions, which corresponds to the emission frequencies F of the plurality of emission sources 9A through 9N from the extracted distance information Li (9A) through Li (9N), and performs a process of selecting the optimum distance image. Then, the optimum distance image selecting unit 194 retrieves the distance image determined to be optimum from the multiple image storage memory 192 and outputs as the optimum distance image.

FIG. 21 is a diagram showing a summary of the process of an exemplary method of selecting the optimum distance image at the optimum distance image selecting unit 194. As shown in FIG. 21, in the distance estimating device 500, precision and resolution of the distance images with respect to the emission frequencies of the plurality of emission sources 9A through 9N within the object region (in FIG. 21, a face region) are compared.

Based on the extracted distance information Li (9A) through Li (9N), the optimum distance image selecting unit 194 determines the optimum distance image from the distance images Img (9A) through Img (9N) by obtaining:

(1) the one with the maximum graduation range of the distance image within the object region;

(2) the one with the graduation characteristic of the distance image within the object region, which is close to linear (the one with pixel values of the distance image within the object region, which has good linearity) (for example, it can be determined that linearity of the pixel values of the distance image is poor in images with extreme change in the pixel values of the distance image in the object region, with saturated pixel values, and the like);

(3) the one with large contrast ratio of the pixels of the distance image within the object region (an absolute value or ratio of a difference between the value of the object pixel and the adjacent pixel value, normalized values of those values, an absolute value or ratio of a difference between the object pixel value and an average value of surrounding pixels in a predetermined range); or the like. For example, when the determination reference denoted by reference numeral (1) above, the optimum distance image selecting unit 194 determines that image Img (9c) is the optimum distance image if the optimum distance image selecting unit 194 determines that the gradation range of the distance information Li (9C) within the object region is maximum. Then, the optimum distance image selecting unit 194 retrieves the distance image Img (9C) from the multiple image storage memory 192 and outputs as the optimum distance image. The optimum distance image may be output directly from the multiple image storage memory 192, or, as shown in FIG. 20, the optimum distance image selecting unit 194 may read out the optimum distance image from the multiple image storage memory 192 and output from the optimum distance image selecting unit 194.

As described above, in the distance estimating device 500 and the distance estimating method according to the present embodiment, pixel values distribution within the distance image corresponding to the object region extracted from the color images is obtained respectively for the distance image data created using the light emitting from the plurality of light sources (infrared light) (light having different frequencies), and the distance image data showing the appropriate pixel values distribution is selected based on the obtained pixel values distributions. In other words, in the distance estimating device 500 and the distance estimating method according to the present embodiment, the distance image which is obtained by the light source of the illumination light having the emission frequency insusceptible to the environment light in the object region on which attention has to be focused can be obtained as the optimum distance image. Thus, the distance image with high precision in the region which requires high attention in the image can be obtained.

The distance estimating device 500 and the distance estimating method according to the present embodiment have an advantage over the distance estimating devices and the distance estimating methods of the second through fourth embodiments in that they do not have to first determine the optimum emission frequency Fbest which is insusceptible to the environment light with none of the plurality of light sources emit light (process at the emission frequency selecting mode), and then perform a process of creating the distance image using reflected light using the illumination light from the predetermined light source (process at the distance image obtaining mode) with mode switching (processes at two modes).

### Other Embodiments

In the above-described embodiments, the distance estimating devices having a plurality of the light sources have been described. However, the present invention is not limited to such devices, and, for example, a light source which can vary the frequency of the light emitted (electromagnetic waves) may be used.

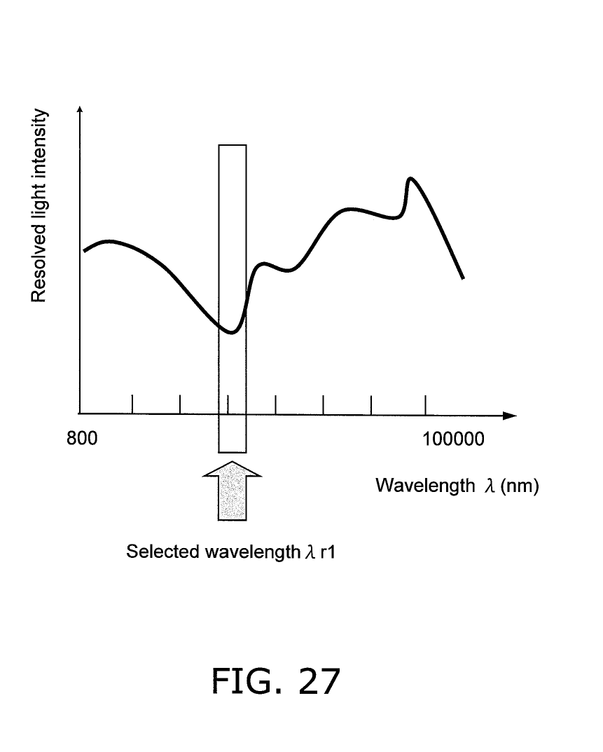

Further, in the above-described embodiments, frequency analysis by Fourier conversion is used as the spectrum analysis at the spectrum analyzing portion 71. However, the reflected light S2 may be dissolved into light intensity having a different wavelength λ, through a spectroscope such as a prism or a diffraction grating or the like and the light intensity may be arranged in the order of the wavelengths in a much simpler way (see FIG. 27). In such a case, since the reflected light is infrared light, the wavelengths are within the infrared region (the range of the wavelengths from 800 [nm] to 100000 [nm]). The light source which emits the wave length λJ1, which is close to the wavelength at which the light intensity is minimum among the light intensities for the wavelength, is selected from the light sources of N number, the first emission source 9A through the Nth emission source 9N. In such case, the wavelengths of the light sources of N number are previously set. Only the light source which emits the selected wavelength may emit light, and the distance image may be created using the light reflected thereof to obtain the distance image insusceptible to the environment light. In such a case, since the light speed is fixed, different wavelengths from the light sources equal to different frequencies from the light sources as mentioned in the above embodiments.

Further, based on the distance image obtained by the present invention, a disparity image for left eye (left eye disparity image of a stereo image) and a disparity image for right eye (right eye disparity image of a stereo image) may be created and a three dimensional image (video) display may be performed on a three dimensional display device by using the created left eye disparity image and right eye disparity image. Still further, in the three dimensional display system comprising the distance measuring device of the present invention and a three dimensional display device, a disparity image for left eye (left eye disparity image of a stereo image) and a disparity image for right eye (right eye disparity image of a stereo image) may be created and a image (video) may be displayed in three dimensions on the three dimensional display device by using the created left eye disparity image and right eye disparity image.

Alternatively, a three dimensional image creating device may be added to the distance measuring device according to the present invention, a disparity image for left eye (left eye disparity image of a stereo image) and a disparity image for right eye (right eye disparity image of a stereo image) may be created at the three dimensional image creating device based on the distance image obtained by the distance measuring device of the present invention, and the created left eye disparity image and right eye disparity image may be output. In this way, the left eye disparity image and right eye disparity image output from the distance measuring device with the three dimensional image creating device being added are used to display a three dimensional image (video) by, for example, a three dimensional display device.

Herein, the disparity image for left eye (left eye disparity image of a stereo image) and the disparity image for right eye (right eye disparity image of a stereo image) may be created by shifting the pixel p in right or left directions in accordance with the distance information z(x, y) of the pixel p (x, y) t the pixel position (x, y) in the image to be referred to when the distance information is known. The distance information z(x, y) may be a relative distance from a predetermined reference (depth value). Alternatively, based on the relationship between the predetermined reference point and the distance information of the pixels in the images, disparity amount of the corresponding pixels may be obtained by a geometrical method such as triangulation.

The distance estimating method an the distance estimating device of the present invention described with reference to the above embodiments are devices which are incorporated in or to be connected to equipment which handle images such as computers, televisions, digital camera, cell phones, PDAs, on-board TVs, and the like, and are embodied as integrated circuits such as LSIs.

More specifically, the distance estimating devices of the above embodiments may be respectively formed into one chip, or some or all of them may be formed into one chip. Herein, it is referred to as LSI, but depending upon the integration degrees, they may also be referred to as IC, system LSI, super LSI, ultra LSI, and so on.

Furthermore, the method of integrated circuit is not limit to LSI, but may be embodied as a special purpose circuit, or a general purpose processor. A field programmable gate array (FPGA), which can be programmed after LSI is manufactured, or a reconfigurable processor, in which connections or settings or circuit cells inside the LSI can be reconfigured may be used.

Further, in advent of technology of integration circuit replacing LSI due to advance in semiconductor technologies or another technologies derived thereof, the functional blocks may be integrated using such technology. Application of biotechnology is a possible example.

The processes by the functional blocks in the above embodiments may be run by programs. The processes by the functional blocks in the above embodiments are performed by central performance unit (CPU), for example, in computers. The programs for running the processes may be stored in storage devices such as hard discs, ROMs and the like, and are run on ROM or read out to RAM.

The processes of the embodiments may be performed by hardware or may be performed by software. Further, they can be performed by both software and hardware. When the distance estimating device according to the above embodiments are embodied by the hardware, of course, timing adjustment for each of the processes are needed. In the above embodiments, for the sake of convenience in description, details on timing adjustment of various signals which is required in the actual hardware design are omitted.

The specific structures of the present invention are not limited to the above embodiments, but may be varied and amended within the scope of the gist of the invention.

### INDUSTRIAL APPLICABILITY

The distance estimating device, distance estimating method, programs, integrated circuits and cameras according to the present invention utilize illumination light insusceptible to environment light to increase a resolution and a frame rate of distance images, and thus, they are useful in video equipment industry. The present invention can be embodied in this field.

### REFERENCE SIGNS LIST

100, 200, 500 Distance estimating device
1 Light receiving optical system
2 Light receiving element unit
3 Charge integrating unit
4 Mode control unit
5 Signal computing unit
6 Image creating unit
7 Emission frequency selecting unit
8 Emission source select control unit
9 Emission source
OBJ10 Object
S1 Illumination light
S2 Reflected light
11 Color separation prism
7A In-area emission frequency selecting unit
10 In-object area charge extracting unit
12 Imaging element unit
13 Color image creating unit
14 Object region extracting unit
190 Emission source control unit
191 Multiple image creating unit
192 Multiple image storage memory unit
193 In-object area distance information extracting unit
194 Optimum distance image selecting unit

1. A distance estimating device for irradiating an object with light having a light intensity being modulated and estimating a distance to the object using light reflected from the object, comprising:
a light source operable to emit light of which a light intensity can be modulated;
an emission source control unit operable to control the light source;
an emission frequency selecting unit operable to determine a frequency of light to be emitted from the light source;
a light receiving optical system operable to condense light from the object;
a light receiving element unit operable to convert light received at the light receiving optical system into charges;
a charge integrating unit operable to integrate charges acquired at the light receiving element unit and acquire a charge signal;
a signal computing unit operable to calculate distance information based on the charge signal; and
an image creating unit operable to create a distance image based on the distance information,
wherein at an emission frequency selection mode:
the emission source control unit controls the light source not to emit light;
the emission frequency selecting unit obtains a frequency spectrum of the charge signal acquired by the charge integrating unit and determines a certain frequency of a frequency band with small frequency component in the frequency spectrum as an optimum emission frequency; and
the emission control unit sets the emission frequency of the light source to the optimum emission frequency, and
wherein at a distance image obtaining mode:
the emission source control unit has the light source emit light using the optimum frequency;
the charge integrating unit acquires the charge signal from the light received with the light source emitting light using the optimum frequency;
the signal computing unit calculates the distance information based on the charge signal obtained from the light received with the light source emitting light using the optimum frequency; and
the image creating unit creates the distance image based on the distance information calculated based on the charge signal acquired from the light received with the light source emitting light using the optimum frequency.

2. A distance estimating device according to claim 1, wherein:
the light source includes a plurality of emission sources having different emission frequencies; and
the emission source control unit selects an emission source having the emission frequency closest to the optimum emission frequency from the plurality of emission sources and controls the selected emission source to emit light at the distance image obtaining mode.

3. A distance estimating device according to claim 2, wherein the plurality of light sources emit light of a frequency of an infrared region.

4. A distance estimating device according to claim 1, further comprising:
a color separation prism operable to separate the light received at the light receiving optical system into light of visible light component and light of infrared light component;
an imaging element unit operable to convert the light of the visible light component which is separated by the color separation prism into a charge signal for image creation;
an image creating unit operable to create an image from the charge signal for image creation which is converted by the image element unit;
an object region extracting unit operable to extract a certain image region in the image created by the image creating unit as an object region; and
an in-object region charge extracting unit operable to extract only the charge signal corresponding to the object region among the charge signal acquired by the charge integrating unit,
wherein the emission frequency selecting unit obtains a frequency spectrum of the charge signal acquired by the in-object region charge extracting unit and determines a certain frequency of a frequency band with small frequency component in the frequency spectrum as an optimum emission frequency.

5. A distance estimating device according to claim 4, wherein the object region extracting unit has an image region of a face as the object region.

6. A distance estimating device according to claim 4, wherein the object region extracting unit has an image region of people as the object region.

7. A distance estimating device according to claim 4, wherein the object region extracting unit has an image region specified by a user as the object region.

8. A distance estimating device according to claim 4, wherein the object region extracting unit treats the image created by the image creating unit with a region separating process, and has an image region separated to large regions as the object region.

9. A distance estimating device according to claim 8, wherein the object region extracting unit performs the region separating process by grouping pixels forming the image based on brightness and color information.

10. A distance estimating device according to claim 8, wherein the object region extracting unit performs the region separating process by performing a block separating process within image in the image created by the image creating unit, and grouping the image blocks based on average brightness information and/or average color information within the separated image blocks.

11. A distance estimating device for irradiating an object with light having a light intensity being modulated and estimating a distance to the object using light reflected from the object, comprising:
a light source operable to emit light of which a light intensity can be modulated;
an emission source control unit operable to control the light source;
a light receiving optical system operable to condense light from the object;
a light receiving element unit operable to convert light received at the light receiving optical system into charges;
a charge integrating unit operable to integrate charges acquired at the light receiving element unit and acquire a charge signal;
a signal computing unit operable to calculate distance info nation based on the charge signal;
an image creating unit operable to create a distance image based on the distance information;
a multiple image storage memory unit operable to store the distance image created by the image creating unit for a multiple number;
an optimum distance image selecting unit operable to select an optimum distance image from the distance image of a multiple number stored in the multiple image storage memory unit;
a color separation prism operable to separate the light received at the light receiving optical system into light of visible light component and light of infrared light component;
an imaging element unit operable to convert the light of the visible light component which is separated by the color separation prism into a charge signal for image creation;
an image creating unit operable to create an image from the charge signal for image creation which is converted by the image element unit;
an object region extracting unit operable to extract a certain image region in the image created by the image creating unit as an object region; and
an in-object region charge extracting unit operable to extract only the charge signal corresponding to the object region among the charge signal acquired by the charge integrating unit, wherein:
the emission source control unit controls the light source to irradiate the object with light having different emission frequencies;
the multiple image storage memory unit stores a multiple number of the distance image created by irradiating the object with light having different emission frequencies from the light source; and
the optimum distance image selecting unit selects an optimum distance image from the multiple number of distance image by evaluating the image data within the object region set by the object region extracting unit based on a predetermined reference among the multiple number of distance image stored in the multiple image storage memory.

12. A distance estimating device according to claim 11, wherein the light source includes a plurality of emission sources having different emission frequencies.

13. A distance estimating device according to claim 12, wherein the plurality of light sources emit light of a frequency of an infrared region.

14. A distance estimating method for irradiating an object with light having a light intensity being modulated and estimating a distance to the object using light reflected from the object, the distance estimating method used in a distance estimating device comprising:
a light source operable to emit light of which a light intensity can be modulated;
a light receiving optical system operable to condense light from the object;
a light receiving element unit operable to convert light received at the light receiving optical system into charges; and
a charge integrating unit operable to integrate charges acquired at the light receiving element unit and acquire a charge signal, the method comprising:
emission source controlling to control the light source;
emission frequency selecting to determine a frequency of light to be emitted from the light source;
signal computing to calculate distance information based on the charge signal; and
image creating to create a distance image based on the distance information,
wherein at an emission frequency selection mode:
the emission source control unit controls the light source not to emit light;
in the step of emission frequency selecting, frequency spectrum of the charge signal acquired by the charge integrating unit is obtained and a certain frequency of a frequency band with small frequency component in the frequency spectrum is determined as an optimum emission frequency; and
in the step of emission controlling, the emission frequency of the light source is set to the optimum emission frequency, and
wherein at a distance image obtaining mode:
in the step of emission source controlling, the light source emit light using the optimum frequency;
in the step of signal computing, the distance information is calculated based on the charge signal obtained from the light received with the light source emitting light using the optimum frequency; and
in the step of image creating, the distance image is created based on the distance information calculated based on the charge signal acquired from the light received with the light source emitting light using the optimum frequency.

15. A non-volatile computer readable storage medium storing a computer-readable program for operating computer to run a distance estimating method for irradiating an object with light having a light intensity being modulated and estimating a distance to the object using light reflected from the object, the distance estimating method used in a distance estimating device comprising:
a light source operable to emit light of which a light intensity can be modulated;
a light receiving optical system operable to condense light from the object;
a light receiving element unit operable to convert, light received at the light receiving optical system into charges; and
a charge integrating unit operable to integrate charges acquired at the light receiving element unit and acquire a charge signal, the program for operating the computer to run the distance estimating method comprising:
emission source controlling to control the light source;
emission frequency selecting to determine a frequency of light to be emitted from the light source;
signal computing to calculate distance information based on the charge signal; and
image creating to create a distance image based on the distance information,
wherein at an emission frequency selection mode:
the emission source control unit controls the light source not to emit light;
in the step of emission frequency selecting, frequency spectrum of the charge signal acquired by the charge integrating unit is obtained and a certain frequency of a frequency band with small frequency component in the frequency spectrum is determined as an optimum emission frequency; and
in the step of emission controlling, the emission frequency of the light source is set to the optimum emission frequency, and
wherein at a distance image obtaining mode:
in the step of emission source controlling, the light source emit light using the optimum frequency;
in the step of signal computing, the distance information is calculated based on the charge signal obtained from the light received with the light source emitting light using the optimum frequency; and
in the step of image creating, the distance image is created based on the distance information calculated based on the charge signal acquired from the light received with the light source emitting light using the optimum frequency.

16. An integrated circuit for a distance estimating device for irradiating an object with light having a light intensity being modulated and estimating a distance to the object using light reflected from the object, the integrated circuit used for the distance estimating device comprising:
a light source operable to emit light of which a light intensity can be modulated; and
a light receiving optical system operable to condense light from the object, the integrated circuit comprising:
an emission source control unit operable to control the light source;
an emission frequency selecting unit operable to determine a frequency of light to be emitted from the light source;
a light receiving element unit operable to convert light received at the light receiving optical system into charges;
a charge integrating unit operable to integrate charges acquired at the light receiving element unit and acquire a charge signal;
a signal computing unit operable to calculate distance information based on the charge signal; and
an image creating unit operable to create a distance image based on the distance information,
wherein at an emission frequency selection mode:
the emission source control unit controls the light source not to emit light;
the emission frequency selecting unit obtains a frequency spectrum of the charge signal acquired by the charge integrating unit and determines a certain frequency of a frequency band with small frequency component in the frequency spectrum as an optimum emission frequency; and
the emission control unit sets the emission frequency of the light source to the optimum emission frequency, and
wherein at a distance image obtaining mode:
the emission source control unit has the light source emit light using the optimum frequency;
the charge integrating unit acquires the charge signal from the light received with the light source emitting light using the optimum frequency;
the signal computing unit calculates the distance information based on the charge signal obtained from the light received with the light source emitting light using the optimum frequency; and
the image creating unit creates the distance image based on the distance information calculated based on the charge signal acquired from the light received with the light source emitting light using the optimum frequency.

17. A camera including a distance estimating device according to claim 1.
